(19) United States
(12) Patent Application Publication
(10) Pub. No.: US 2011/0242948 A1
(43) Pub. Date: Oct. 6, 2011

(54) OPTICAL DISC DEVICE AND OPTICAL DISC

(76) Inventors: Tatsuo Suzuki, Kyoto (JP); Katsuya Watanabe, Nara (JP); Hiroyuki Yabuno, Osaka (JP)

(21) Appl. No.: 12/599,344

(22) PCT Filed: May 16, 2008
(86) PCT No.: PCT/JP2008/001223

§ 371 Date: Nov. 9, 2009

(30) Foreign Application Priority Data
May 18, 2007 (JP) 2007-132256

(51) Int. Cl. G11B 7/007

(52) U.S. Cl. 369/30.03; 369/44.26; G9B/7.029

(57) ABSTRACT

There is provided an optical disc device including an objective lens, a lens actuator for driving the objective lens, a light-receiving unit, and a system control unit which determines, at startup, the values of parameters to be set for recording or reproducing data in or from the respective information layers, and performs setting and management of recording inhibition or reproduction inhibition for the respective information layers, wherein, even when an error occurs because the values of the parameter groups for the respective layers cannot be determined in an optical disc having laminated plural information layers, recording or reproduction can be performed for at least the layers for which the parameters can be correctly determined, without stopping the startup. Thereby, the states of the respective information layers are managed for each information layer, and reproduction or recording operation is rapidly started in the respective layers to effectively utilize the multilayer disc.

### TECHNICAL FIELD

The present invention relates to recording of data into a disk-shaped information carrier (hereinafter referred to as “optical disc”), and an optical disc device which performs recording and reproduction in and from an optical disc. More particularly, the invention relates to an efficient disc error handling method for a large-capacity optical disc having a plurality of information layers, and an optical disc device which can realize the method.

### BACKGROUND ART

Data recorded on an optical disc are reproduced by irradiating a rotating optical disc with a light beam having a relatively-low constant light quantity, and detecting the reflected light that is modulated by the optical disc.

On a playback-only optical disc, data have previously been recorded spirally by pits in the manufacturing stage of the optical disc. In contrast, on a rewritable optical disc, a recording material film capable of optical data recording/reproduction is deposited by a method such as vapor deposition on a surface of a base material on which spiral tracks having lands and grooves are formed. When recording data on the rewritable optical disc, the optical disc is irradiated with a light beam whose light quantity is modulated according to the data to be recorded, and thereby the characteristics of the recording material film are locally varied to perform data writing.

The depth of pits, the depth of tracks, and the thickness of the recording material film are smaller than the thickness of the optical disc base material. Therefore, the portion of the optical disc where the data are recorded configures a two-dimensional plane, and it is sometimes referred to as a “recording plane”. In this specification, considering that such recording plane has a physical size also in the depth direction, a term “information layer” is used instead of the term “recording plane”. An ordinary optical disc has at least one information layer. Actually, one information layer may include a plurality of layers such as a phase change material layer and a reflection layer.

When recording data on the recordable optical disc or when reproducing the data recorded on such optical disc, the light beam must be constantly in a predetermined converged state on a target track on the information layer. For this purpose, “focus control” and “tracking control” are required. The “focus control” is to control the position of the objective lens in the normal direction of the information recording surface so that the focal point of the light beam is constantly positioned on the information layer. On the other hand, the “tracking control” is to control the position of the objective lens in the radial direction of the optical disc (hereinafter referred to as “disc radial direction”) so that the spot of the light beam is positioned on a predetermined track.

Conventionally, optical discs such as DVD (Digital Versatile Disc)-ROM, DVD-RAM, DVD-RW, DVD-R, +RW, and +R have been practically used as high-density and large-capacity optical discs. Meanwhile, CDs (Compact Discs) are now in widespread use. At present, development and practical application of next-generation optical discs such as Blu-ray Disc (BD) having higher density and larger capacity relative to those optical discs have been advanced.

These optical discs have different physical configurations depending on their types. For example, the physical configuration of the tracks, the track pitch, the depth of the information layer (i.e., the distance from the light incident surface of the optical disc to the information layer) and the like vary among the optical discs. In order to appropriately read or write data from or in the plural types of optical discs having different physical configurations, it is necessary to irradiate the information layer of each optical disc with a light beam of an appropriate wavelength, using an optical system having a numerical aperture (NA) suited to the type of the optical disc.

In recent years, an optical disc having two information layers in its thickness direction has appeared as a large-capacity recording medium, and optical disc devices corresponding to this optical disc have been widely marketed.

The optimum state of servo control/signal which is required for performing recording and reproduction of an optical disc varies depending on variations in characteristics among optical disc devices or optical disc, the temperature condition when performing recording and reproduction, and the like. Therefore, when performing recording and reproduction on the information layer of the optical disc, initial adjustment for servo (control)/signal (recording), which is called “startup process” must be performed in a predetermined procedure. By performing the startup process, recording and reproduction on the information layer of the optical disc can be performed in the optimum state. However, recording error or servo adjustment error might occur at startup due to various factors including problems concerning the initial characteristics and archival characteristics of the disc, deterioration of the disc caused by the number of times of rewriting, and the like.

Patent Document 1 discloses a technique for solving a part of the above-mentioned problems. FIG. 15 is a flowchart including a step of inhibiting recording when errors occur during test writing at startup by a predetermined number of times or more, which flowchart is described in Patent Document 1. By applying this technique, even when a recording error occurs in an optical disc, only reproduction is executed in this disc to avoid degradation in the reproduction characteristics of the disc or block possible advance in such as error recording, and thereby backup into a different media such as an HDD by user's hand is promoted.
Patent Document 1: Japanese Published Patent Application No. Hei. 6-36474
Patent Document 2: U.S. Pat. No. 611,533

### DISCLOSURE OF THE INVENTION

### Problems to be Solved by the Invention

When the above-described conventional art is applied to a two-layer or multilayer disc, since initial adjustment is performed for each information layer, the time required for the startup process increases, and further, a startup adjustment error or a startup learning error might occur due to various factors including problems concerning the quality and characteristics of the disc, the number of times of rewriting, and the like. The probability of such error increases in proportion to the number of the information layers. To be specific, when an adjustment error relating to servo focusing or tracking occurs, the startup is stopped. Further, when there occurs an error by which the recording power during test writing or the width of the modulation pulse as a recording compensation value exceeds a threshold value, a predetermined number of retries are carried out. If recovery cannot be still performed, recording is stopped, and if the error is serious, startup is stopped. In this case, however, the frequency of stopping due to a startup error and the frequency of recording inhibition are increased in a multilayer media having a larger number of layers.

For example, in the case of a two-layer disc, even though all the learnings have been normally completed in the first layer corresponding to ½ of the disc capacity, if the learnings in the second layer have not been normally completed, recording cannot be performed to not only the second layer but also the first layer. Particularly when the capacity per layer is as large as 25 GB such as BD, the whole disc becomes inrecordable although the disc can record more than two hours of digital hi-vision broadcasting by only the first layer thereof.

The present invention is made to solve the above-described problems and has for its object to provide an optical disc device which can manage the states of the respective information layers of an optical disc for each information layer so that reproduction or recording can be rapidly started in each layer, thereby to effectively utilize the disc.

### Measures to Solve the Problems

In order to solve the above-described problems, there is provided an optical disc device which is able to perform data recording and data reproduction in and from an optical disc having laminated M (M≧2) pieces of information layers, comprising: an objective lens which focuses a light beam; a lens actuator which drives the objective lens; a light-receiving unit which receives the light beam reflected by the optical disc, and converts the light beam into an electric signal; a reproduction unit which processes the signal from the light-receiving unit to reproduce a signal on the optical disc; a control unit which performs, at starting the optical disc device, learning for determining the values of parameters that are set for recording and reproducing data in and from at least one information layer among the M pieces of information layers; and a management unit which performs setting and management of inhibition or permission for recording or reproduction in or from the respective M pieces of information layers; wherein the management unit performs setting of inhibition or permission for recording or reproduction to the respective information layers according to the result of the learning performed by the control unit.

Further, in the above-described optical disc device, when the control unit could have determined the values of the parameters of the respective information layers at startup, the management unit performs setting of inhibition or permission for recording or reproduction to the respective information layers according to the determined values of the parameters of the respective information layers.

Further, in the above-described optical disc device, when the control unit could not have determined the values of the parameters for any of the information layers at startup, the management unit performs setting of inhibition or permission for recording or reproduction to the respective information layers.

Further, in the above-described optical disc device, when the reproduction unit could not have read values peculiar to the optical disc or the information layers at startup, which values are recorded in specific areas of the respective information layers, the management unit performs setting of inhibition or permission for recording or reproduction to the respective information layers.

Further, in the above-described optical disc device, at least one of parameters relating to spherical aberration or focus control is included as the parameters of the respective information layers.

Further, in the above-described optical disc device, at least one of parameters relating to recording powers or recording compensation values is included as the parameters of the respective information layers.

Further, in the above-described optical disc device, inter-layer jumping is performed with skipping a recording-inhibited layer or reproduction-inhibited layer in the optical disc, thereby to perform data recording or data reproduction.

Further, in the above-described optical disc device, flags are set on R (1≦R≦M) pieces of information layers among the M pieces of information layers in the optical disc, and when the values of the parameters could not have been determined for N (N≦R) pieces of information layers among the R pieces of information layers at starting the optical disc device, the information layers for which the parameter values could not have been determined are hidden by the flags, thereby to control the optical disc as a (M−N) layer disc.

Further, in the above-described optical disc device, the optical disc is a two-layer disc having two information layers, and when the values of the parameters could not have been determined for one of the two information layers, which is closer to a light incident surface of the optical disc, the optical disc is controlled as a single-layer disc.

Further, in the above-described optical disc device, the values of the parameters of the respective information layers which have been determined by the control unit and information as to whether the control unit could have determined the values of the parameters of the respective information layers or not are recorded in a predetermined area of the optical disc.

Further, in the above-described optical disc device, when the values of the parameters could not have been determined for N (N≦R) information layers among the R information layers at starting the optical disc device, information for identifying the optical disc as a (M−N) layer disc is recorded in a predetermined area of any information layer among the information layers for which the values of the parameters could have been determined.

Further, in the above-described optical disc device, information of recording inhibition or reproduction inhibition for the respective information layers, which is set by the management unit, is recorded in a predetermined area of the optical disc.

Further, the above-described optical disc device further includes a finalization unit which performs finalization for fabrication of a recordable optical disc, and the finalization unit is operated to embed arbitrary data in an unrecorded area of the recordable optical disc, thereby to finalize fabrication of a recordable optical disc.

Further, in the above-described optical disc device, when the optical disc is controlled as a (M−N) layer disc, data recording or data reproduction is performed with using a logical address at the head of an information layer for which the values of the parameters could have been determined among the information layers in the (M−N) layer disc, as a start address of the (M−N) layer disc.

Further, in the above-described optical disc device, when data recording or data reproduction is controlled with the optical disc being a (M−N) layer disc, data recording or data reproduction is performed with using a final logical address of an information layer for which the values of the parameters could have been determined among the information layers in the (M−N) layer disc, as a final address of the (M−N) layer disc.

Further, according to the present invention, there is provided an optical disc device which is able to perform data reproduction from an optical disc having laminated M (M≦2) pieces of information layers, comprising: an objective lens which focuses a light beam; a lens actuator which drives the objective lens; a light-receiving unit which receives the light beam reflected by the optical disc, and converts the light beam into an electric signal; a reproduction unit which processes the signal from the light-receiving unit to reproduce a signal on the optical disc; and an identification unit which identifies the optical disc; wherein values of parameters which are set for reproducing data from the respective information layers, and identification information indicating whether the values of the parameters could have been determined for the respective information layers or not are recorded in a predetermined area of the optical disc, and the identification unit reads out the identification information to identify the optical disc.

Further, in the above-described optical disc device, when information indicating that the values of the parameters could not have been determined for any N (M>N) pieces of layers among the M pieces of information layers is recorded in the optical disc as the identification information, the optical disc is controlled as a (M−N) layer disc.

Further, according to the present invention, there is provided an optical disc which is obtained by laminating M (M≧2) pieces of layers including spare layers.

Further, in the above-described optical disc, the M pieces of layers include layers which are determined in the standard or specification of the optical disc, and spare layers, and information indicating the number of actually laminated layers including the number of the layers determined in the standard or specification of the optical disc and the number of the spare layers, is recorded in a predetermined area.

Further, in the above-described optical disc, when the values of the parameters to be set for data recording or data reproduction could not have been determined for N (M>N) pieces of layers among the M pieces of layers, information for identifying the optical disc as a (M−N) layer disc is recorded.

Further, the above-described optical disc is a parallel track path system multilayer disc.

Further, the above-described optical disc is an opposite track path system multilayer disc.

Further, according to the present invention, there is provided an optical disc device which can perform data reproduction from an optical disc having laminated M (M≧2) pieces of information layers, comprising: an objective lens which focuses a light beam; a lens actuator which drives the objective lens; a light-receiving unit which receives the light beam reflected at the optical disc, and converts the light beam into an electric signal; a reproduction unit which processes the signal from the light-receiving unit to reproduce a signal on the optical disc; and a standard number-of-layers identification unit which identifies the number of layers in the optical disc; wherein the optical disc includes laminated M (M≧2) pieces of layers including spare layers, the M pieces of layers comprising layers that are determined in the standard or specification of the optical disc and the spare layers, and information indicating the number of the actually laminated layers including the number of the layers determined in the standard or specification of the optical disc and the number of the spare layers is recorded in a predetermined area, the standard number-of-layers identification unit identifies the number of the layers determined in the standard or specification, from the information relating to the number of layers, and only the layers in the number determined in the standard or specification, which are identified by the standard number-of-layers identification unit, are used for data reproduction.

Further, the above-described optical disc device includes an address conversion unit which converts discontinuous physical addresses into continuous logical addresses by using addresses of only the layers in the number determined in the standard or specification of the optical disc.

Further, in the above-described optical disc device, the address conversion unit converts discontinuous physical addresses into continuous logical addresses by using addresses of only the layers in the number determined in the standard or specification so that track paths of the optical disc are alternate track paths.

Further, according to the present invention, there is provided an optical disc device which can perform data recording and data reproduction in and from an optical disc having laminated M (M≧2) pieces of information layers, comprising: an objective lens which focuses a light beam; a lens actuator which drives the objective lens; a light-receiving unit which receives the light beam reflected at the optical disc, and converts the light beam into an electric signal; a reproduction unit which processes the signal from the light-receiving unit to reproduce a signal on the optical disc; and a data recording/reproduction management unit which manages the data recorded or reproduced in or from each of the M pieces of information layers; wherein the data recording/reproduction management unit records backup data of the recording data to be recorded in the respective information layers, in information layers different from the information layers in which the recording data are recorded.

Further, in the above-described optical disc device, the data recording/reproduction management unit performs mirror recording which makes the recording data and the backup data equal to each other, and makes the recording positions of the recording data in the information layers and the recording positions of the backup data in the information layers equal to each other, when recording the backup data in the respective information layers.

Further, according to the present invention, there is provided an optical disc device which is able to perform data recording and data reproduction in and from an optical disc including M (M≧2) pieces of information layers having different physical configurations from each other, comprising: an objective lens which focuses a light beam; a lens actuator which drives the objective lens; a light-receiving unit which receives the light beam reflected by the optical disc, and converts the light beam into an electric signal; a reproduction unit which processes the signal from the light-receiving unit to reproduce a signal on the optical disc; and a data recording/reproduction management unit which manages the data recorded or reproduced in or from each of the M pieces of information layers; wherein the data recording/reproduction unit records backup data of the recording data to be recorded in the respective information layers, in information layers different from the information layers in which the recording data are recorded.

Further, the above-described optical disc device includes a recording data compression unit for compressing the recording data, and the recording/reproduction management unit records the backup data after the recording data to be recorded in the respective information layers are compressed by the recording data compression unit.

Further, in the above-described optical disc device, the data recording/reproduction management unit reproduces the backup data corresponding to the recording data when the recording data recorded in the respective information layers cannot be reproduced.

Further, in the above-described optical disc device, the backup data has a recording format which can be reproduced by an optical disc device which can reproduce only the information layers in which the backup data are recorded.

Further, according to the present invention, there is provided an optical disc including M pieces of information layers having different physical configurations from each other, wherein backup data of recording data to be recorded in the respective information layers are recorded in information layers different from the information layers in which the recording data are recorded, the backup data are recorded in a recording format which is reproducible by an optical disc device that can reproduce only the information layers in which the backup data are recorded, and the thickness of a light transmission layer in the information layer in which the backup data are recorded is 0.6 mm±0.03 mm.

### Effects of the Invention

According to the present invention, in an optical disc device which performs recording and reproduction of an optical disc having a plurality of information layers, the states of the respective information layers, i.e., a layer being capable of recording and reproduction, a layer being incapable of recording but capable of reproduction, and a layer being incapable of recording and reproduction, are accurately managed for the respective information layers depending on whether adjustment or learning for the various parameters which is performed at starting the device is normally completed in the respective layers or not, and whether the converged values of the parameters obtained in the adjustment or learning are appropriate ones or not. Therefore, failure of program recording or missing of recording time, which might be caused by a startup error in such as time-shift recording, can be reduced, whereby the usability is enhanced, and the optical disc can be effectively utilized. Furthermore, if an optical disc having three or four information layers will be developed in the future, the effect of managing and executing the recording/reproduction effective states for the respective layers will be more remarkable.

Further, according to the optical disc of the present invention, since the spare information layers are provided, even when there exists an unusable information layer in the optical disc, recording and reproduction can be carried out using the spare information layer without degrading the disc capacity determined in the standard or specification. Further, the optical disc device can recognize the number of layers determined in the standard or specification in a relatively short time by previously recording the number of layers determined in the standard or specification and the actual number of layers including the spare information layers in the optical disc.

Further, according to the optical disc device of the present invention, since backup data of the recording data to be recorded in the respective information layers are recorded in the information layers which are different from the information layers in which the recording data are to be recorded, even when data recording into a certain information layer has failed or data reproduction from the information layer cannot be performed for some reasons, the backup data can be reproduced from the other information layer, thereby enhancing the reliability of data recording or data reproduction.

### BRIEF DESCRIPTION OF THE DRAWINGS

FIG. 1 is a perspective view illustrating the schematic positional relation between an optical disc 201 loaded on an optical disc device and an objective lens 202.

FIG. 2 is a cross-sectional view illustrating the configuration of the optical disc 201 having a plurality of information layers.

FIG. 3(a) is a diagram illustrating the state where a spherical aberration occurs, and FIG. 3(b) is a diagram illustrating the state where the spherical aberration is corrected.

FIG. 4(a) is a diagram illustrating the state where the spherical aberration is minimized on an information layer which is located at a relatively shallow position from the surface of the optical disc 201, and FIG. 4(b) is a diagram illustrating the state where the spherical aberration is minimized on an information layer which is located at a relatively deep position from the surface of the optical disc 201.

FIGS. 5(a) and 5(b) are diagrams illustrating an aberration correction lens 262 which is moved in the light axis direction for aberration correction, and FIG. 5(c) is a diagram illustrating the relation between the position of the aberration correction lens 262 and the depth of the information layer on which the spherical aberration is minimized.

FIG. 6 is a block diagram illustrating the configuration of an optical disc device according to a first embodiment.

FIG. 7 is a flowchart illustrating the outline of a startup process in the optical disc device of the first embodiment.

FIG. 8 is a block diagram illustrating the configuration of an optical disc device according to a second embodiment.

FIG. 9 is a schematic diagram for explaining learning for recording according to the second embodiment.

FIG. 10 is a flowchart illustrating the outline of a startup process by the optical disc device of the second embodiment.

FIG. 11 is a block diagram illustrating the configuration of an optical disc device according to a third embodiment.

FIG. 12 is a block diagram illustrating the configuration of an optical disc device according to a fourth embodiment.

FIG. 13 is a block diagram illustrating the configuration of an optical disc device according to a fifth embodiment.

FIG. 14 is a diagram illustrating physical layers and logical layers of the optical disc of the fifth embodiment.

FIG. 15 is a flowchart illustrating the procedure of test recording which is performed during an optical disc startup process by an optical disc device disclosed in Patent Document 1.

FIG. 16 is a block diagram illustrating the configuration of an optical disc device according to a sixth embodiment.

FIG. 17 is a block diagram illustrating the configuration of an optical disc device according to a seventh embodiment.

FIG. 18 is a diagram illustrating the configuration of an optical disc according to the seventh embodiment.

FIG. 19 is a diagram illustrating an example of an optical disc having physical layers which are larger in number than physical layers on the standard according to the fifth embodiment.

FIG. 20 is a diagram illustrating an example of an optical disc having physical layers which are larger in number than physical layers on the standard according to the fifth embodiment.

FIG. 21 is a diagram for explaining a multilayer disc control method according to the first and second embodiments.

### DESCRIPTION OF REFERENCE NUMERALS

100 . . . optical disc device of the first embodiment
200 . . . optical disc device of the second embodiment
300 . . . optical disc device of the third embodiment
400 . . . optical disc device of the fourth embodiment
500 . . . optical disc device of the fifth embodiment
600 . . . optical disc device of the sixth embodiment
700 . . . optical disc device of the seventh embodiment
22 . . . light beam
90 . . . circuit part
190 . . . circuit part
201,1001,1002,1003 . . . optical disc
201a . . . light incident side surface
202 . . . objective lens
203 . . . actuator
204 . . . spherical aberration position adjustment unit
205 . . . light-receiving unit
206 . . . actuator driving unit
207 . . . spherical aberration position driving unit
208 . . . focus error generation unit
209 . . . tracking error generation unit
210 . . . signal reproduction unit
211 . . . data reproduction unit
212 . . . servo control unit
213 . . . system control unit
214 . . . disc motor
215 . . . optical pickup
216 . . . adjustment parameter processing unit
260 . . . spherical aberration correction unit
262 . . . aberration correction lens
290 . . . circuit part
301 . . . semiconductor laser
302 . . . laser driving unit
303 . . . recording control unit
305 . . . IF unit
310 . . . host
390 . . . circuit part
401 . . . identification unit
402 . . . standard number-of-layers identification unit
403 . . . address conversion unit
490 . . . circuit part
501 . . . finalization unit
590 . . . circuit part
601 . . . data recording/reproduction management unit
690 . . . circuit part
701 . . . recording data compression unit
702 . . . BD disc
703 . . . DVD disc

### BEST MODE TO EXECUTE THE INVENTION

An optical disc of the present invention is a multilayer optical disc having laminated M (M≧2) pieces of information layers, and each information layer has “a layer-basis adjustment result storage area”.

The layer-basis adjustment result storage area stores not only the results of adjustment and learning which are performed in the own layer, but also the results of adjustment and learning which are performed in another layer by a startup sequence if the results are known. Accordingly, assuming that the information layers from the first layer to the n-th layer are successively learned to be started, the first layer stores the learning result of the own layer, the second layer stores the learning results of the own layer and the first layer which has previously been learned, the third layer stores the learning results of the own layer and the first and second layers which have previously been learned, and thus the learning results of all the information layers are stored in the layer-basis adjustment result storage area of the n-th layer.

The learning to be performed at startup is to calculate optimum parameters for the focus position, the spherical aberration correction amount, the lens tilt correction amount, the servo loop gain, the offset correction amounts for focus and tracking controls, the laser power for performing recording, and the width and interval of the laser modulation pulse signal, so as to optimize the light beam convergent state in a target information layer to be subjected to recording and reproduction.

Hereinafter, the present invention will be described with respect to, for example, a first embodiment which performs learning of the focus position and the spherical aberration correction amount which influence both recording and reproduction among the above-mentioned learnings, and a second embodiment which performs learning of the recording power which influences recording.

### Embodiment 1

In advance of explaining the first embodiment of the present invention, information required for optimizing the light beam convergent state which depends on the spherical aberration and the focus position will be described.

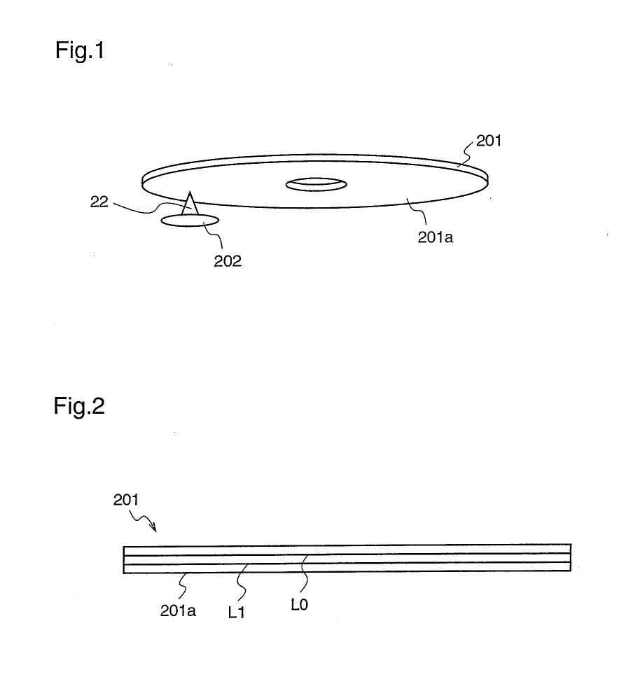

First of all, the locational relation between an ordinary optical disc 201 and an objective lens 202 will be described with reference to FIG. 1 which is a perspective view schematically illustrating the locational relation.

In FIG. 1, a light beam 22 which is converged by the objective lens 202 is applied to an information layer in the optical disc 201 through a light incident surface 201a of the optical disc 201, and thereby a light beam spot is formed on the information layer. As shown in FIG. 2, an example of the optical disc 201 used in this invention comprises a first information layer (L0 layer) which is provided at a relatively deep position from the light incident surface 201a, and a second information layer (L1 layer) which is provided at a relatively shallow position from the light incident surface 201a. Therefore, in order to accurately converge the light beam 22 onto the information layer (L0 layer or L1 layer) which is a target of recording or reproduction, it is necessary to appropriately adjust the position of the objective lens 202 in the light axis direction and the tilt angle of the light axis with respect to the information plane.

Especially in the BD among the above-described various optical discs 201, since the light beam 22 is converted using an objective lens having a high numerical aperture (NA), the signal reproduction quality is likely to be affected by the “spherical aberration”. In order to minimize this spherical aberration, a spherical aberration correction unit 260 for correcting the spherical aberration is provided between the light source (not shown) and the objective lens 202 because an optical disc device adapted to the BD is configured to irradiate the BD with the light beam 22.

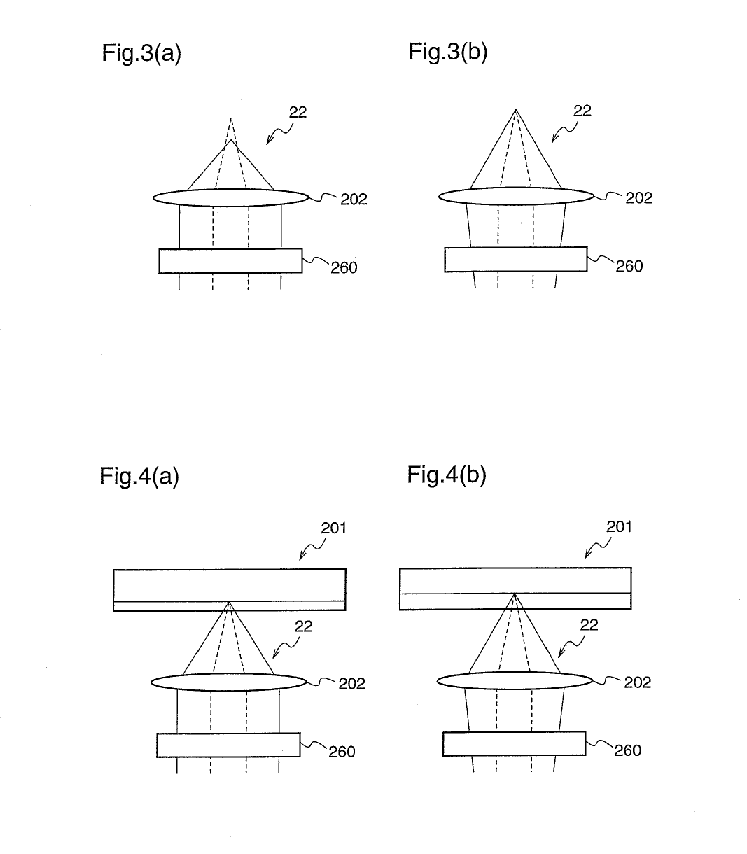

As shown in FIG. 3(a), the spherical aberration is a phenomenon that the position of the focal point deviates along the light axis direction between the light beam which passes through the center portion of the objective lens 202 and the light beam which passes through the peripheral portion of the objective lens 202, and the extent of the deviation itself is sometimes referred to as “spherical aberration”. The spherical aberration varies depending on the wavelength of the light beam 22, the numerical aperture of the objective lens 202, and the transmission layer thickness in the optical disc 201, i.e., the distance from the disc surface to the information layer. Particularly, the spherical aberration significantly depends on the numerical aperture, and it varies in proportion to the fourth power of the numerical aperture. Thereby, the spherical aberration particularly tends to increase in the BD using an objective lens having a numerical aperture larger than that of DVD or CD, and thus a reduction in the spherical aberration is indispensable.

The term “transmission layer thickness” in the present invention means the distance from the light incident surface 201a of the optical disc 201 (hereinafter referred to as “disc surface”) to the information layer, in other words, the depth of the information recording layer from the disc surface. In the case of a single-layer BD having one information layer, since the information layer is covered with a cover layer having a thickness of 0.1 mm (about 100 μm), the “transmission layer thickness” is uniquely determined to 0.1 mm. In the case of a two-layer BD having two information layers, a light transmission layer having a thickness of about 25 μm is disposed on one information layer (L0 layer) that is farther from the disc surface, and the other information layer (L1 layer) is disposed on the light transmission layer. This L1 layer is covered with a cover layer that is another light transmission layer having a thickness of about 75 μm. Therefore, in the two-layer BD, the “transmission layer thickness” focused on the L1 layer is about 75 μm while the “transmission layer thickness” focused on the L0 layer is about 100 μm.

Even among plural optical discs 201 fabricated based on the same standard for BD, the extend of the spherical aberration varies if the transmission layer thickness varies or the light axis of the light beam 22 is tilted with respect to the information layer. Therefore, it is necessary to optimize the aberration correction amount by controlling the spherical aberration correction unit 260 to minimize the spherical aberration according to the optical disc 201 loaded on the optical disc device. FIG. 3(b) schematically shows the state where the spherical aberration is completely corrected by the spherical aberration correction unit 260.

FIG. 4(a) shows the state where the spherical aberration is minimized on the information layer which is located at a relatively shallow position from the surface of the optical disc 201, and FIG. 4(b) shows the state where the spherical aberration is minimized on the information layer which is located at a relatively deep position from the surface of the optical disc 201. When the distance from the surface of the optical disc 201 to the information layer varies in this way, the spherical aberration on each information layer must be minimized by adjusting the exitance of the light beam 22 incident on the objective lens 202 by the action of the spherical aberration correction unit 260.

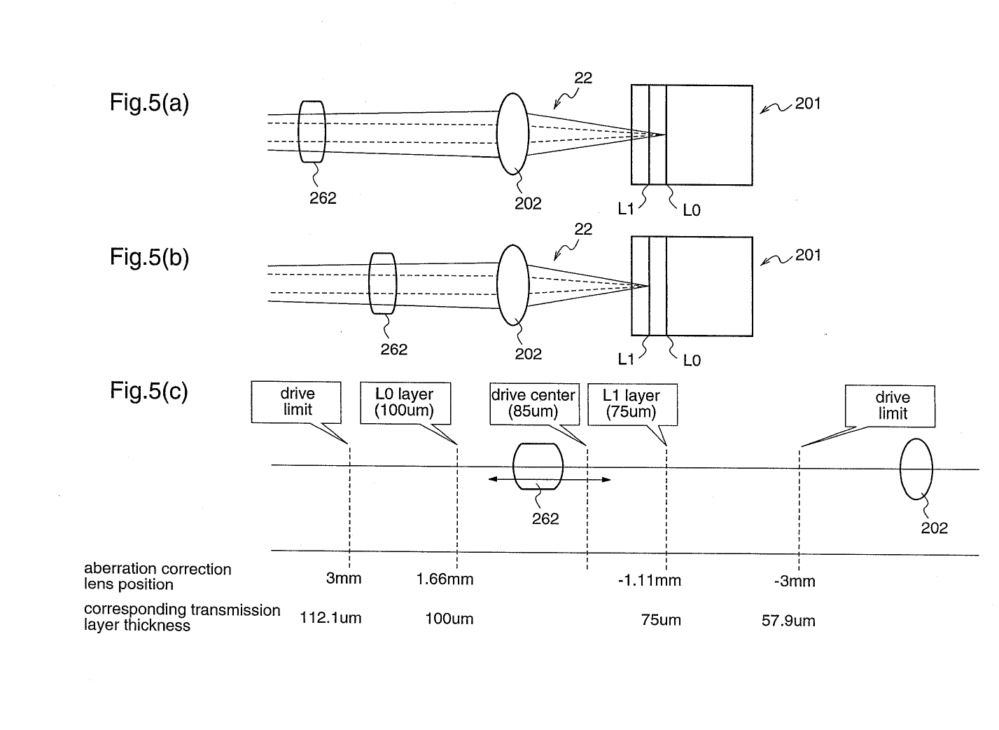

The spherical aberration correction unit 260 is provided with an aberration correction lens 262 shown in FIGS. 5(a) and 5(b) to adjust the exitance of the light beam 22 incident on the objective lens 202, and the exitance of the light beam 22 can be varied by varying the position of the aberration correction lens 262 in the light axis direction to finally adjust the spherical aberration on the information layer.

In the state shown in FIG. 5(a), the spherical aberration is minimized on the L0 layer which is located at a relatively deep position in the optical disc 201, by moving the aberration correction lens 262 apart from the objective lens 202.

On the other hand, in the state shown in FIG. 5(b), the spherical aberration is minimized on the L1 layer which is located at a relatively shallow position in the optical disc 201, by moving the aberration correction lens 262 close to the objective lens 202.

As shown in FIG. 5(c), the depth of the information layer on which the spherical aberration is minimized can be varied by controlling the position of the aberration correction lens 262. When the aberration correction lens 262 is located at a position apart from the objective lens 202 by 1.66 mm with respect to the drive center, the spherical aberration can be minimized on the L0 layer. On the other hand, when the aberration correction lens 262 is located at a position close to the objective lens 202 by 1.11 mm with respect to the drive center, the spherical aberration can be minimized on the L1 layer.

The distance or depth from the optical disc surface to the L0 layer is represented by “transmission layer thickness of 100 μm”, and the distance or depth from the optical disc surface to the L1 layer is represented by “transmission layer thickness of 75 μm”.

Accordingly, when positioning the focal point of the light beam 22 onto the L1 layer, it is necessary to move the aberration correction lens 262 by 1.11 mm from the drive center toward the objective lens side to perform aberration correction suited to the transmission layer thickness of 75 μm, in addition to adjusting the position of the objective lens 202 in the light axis direction. When moving the focal point of the light beam 22 from the L1 layer to the L0 layer, the position of the objective lens 202 in the light axis direction is adjusted, and simultaneously, the aberration correction lens 262 is moved to a position apart from the objective lens 202 by 1.66 mm with respect to the drive center to perform aberration correction suited to the transmission layer thickness of 100 μm. At this time, if only the position of the objective lens 202 is adjusted and aberration correction is not appropriately performed, the spherical aberration of the light beam 22 focused on the L0 layer is undesirably increased.

As described above, as for the BD, it is necessary not only to adjust the position of the objective lens 202 so as to position the focal point of the light beam 22 on the target information layer but also to adjust the position of the aberration correction lens 262 so as to minimize the spherical aberration on the information layer.

Accordingly, in the above-described example, the position of the objective lens 202 in the light axis direction and the position of the aberration correction lens 262 in the light axis direction are the important parameters for defining the convergent state of the light beam 22. In this application, the position of the objective lens 202 in the light axis direction in the optical pickup is sometimes referred to as “focus position” or “defocus position”. Further, the position of the aberration correction lens 262 in the light axis direction is sometimes referred to as “aberration correction position” or “aberration correction amount”.

Since the “defocus amount” is sometimes referred to as “focus balance”, the light axis direction position of the objective lens 202 in the optical pickup is sometimes referred to as “FBAL”. Further, since the aberration correction lens 262 has a beam expanding function for expanding the light beam 22, the “aberration correction position” or the “aberration correction amount” is sometimes represented simply as “BE”.

Further, control for the orientation of the objective lens 202 in the light axis direction is referred to as “tilt control”.

While the initial value of the orientation of the light axis of the objective lens 202 is 0°, if the information surface of the optical disc 201 tilts from a plane perpendicular to the light axis of the objective lens 202, the orientation of the light axis of the objective lens 202 must be tilted according to the tilt angle. Therefore, this tilt angle is also one of parameters which influence the convergent state of the light beam 22.

The values of the above-described parameters which significantly influence the convergent state of the light beam 22 vary due to various factors shown in the following Table 1, and these variation factors can be classified into factors depending on the optical disc device, factors depending on the optical disc 201, and factors depending on the usage environment.

TABLE 1

| | |
|---|---|
| Optical disc device | Variations in characteristics among |
| Dependency | devices such as alignment errors during |
| | fabrication |
| Optical disc dependency | Recording film characteristics, |
| | transmission layer thickness, bonding |
| | unevenness which occurs during optical |
| | disc fabrication, disc eccentricity |
| Environment dependency | Temperature variation |

In order to actually record data or reproduce already-recorded data in or from the multilayer optical disc, the individual information layers must be subjected to adjustment for optimizing the convergent state of the light beam 22 immediately after starting the optical disc device. That is, the values of the “focus position (FBAL)” and the “aberration correction position (BE)” must be adjusted according to the optical disc 201 loaded on the optical disc device so as to optimize the positions of the objective lens 202 and the aberration correction lens 262 in the light axis direction.

The adjustment and determination of the lens positions are also called “learning”, and it is executed as a “startup process” simultaneously with other processes to be performed at startup, such as optimization for the laser power.

The values of FBAL and BE relating to the respective information layers, which are obtained by performing such adjustment or learning, are recorded in the optical disc 201 or stored in the memory in the optical disc device. However, such adjustment or learning must be newly performed when the optical disc 201 or the optical disc device is changed, and the respective information layers of the optical disc 201 must be subjected to adjustment for the focus position and the aberration correction position every time it is started even in the same optical disc 201 or optical disc device.

Accordingly, when the number of the information layers included in one optical disc 201 is increased to two or more, startup might be stopped with the first layer being correctly adjusted and the second layer having an adjustment error, or startup might be stopped as a startup error at the timing when the first layer has an adjustment error even if there is a possibility that the second layer might be correctly adjusted, as described as the problem of the conventional art, and thus the operation cannot go to recording or reproduction unless both the two layers are correctly adjusted.

For example, considering the following situations and conditions:

1) The first L0 layer has less thickness unevenness while the second L1 layer has considerable thickness unevenness;

2) dust is attached to the surface of the optical disc, and the second L1 layer closer to the surface is significantly affected by the dust; and

3) since the intermediate layer has a low reflectivity, i.e., a high transmissivity, the first L0 layer has a marginal power but the second L1 layer has no marginal power; it is assumed that learning of the focus position and the spherical aberration on the second L1 layer might fail while learning of the focus position and the spherical aberration on the first L0 layer might be normally completed, and further, jitter degradation and lack of power margin might occur due to disc factors, and thereby the recording power might exceed a predetermined level even though learning of the recording power is carried out. Accordingly, when the adjusted values of the focus position and the aberration correction position exceed the estimated values, the first L0 layer is permitted for recording while the second L1 layer is inhibited for recording.

Further, when an error such as deviation of tracking servo occurs during adjustment of the focus position and the aberration correction position on the second L1 layer and thereby the adjustment cannot be completed, the adjusted values are returned to the initial values, and thereafter, the second L1 layer is set in the unrecordable and unreproducible state. In this case, the optical disc may be treated as a single-layer disc.

Also in the case of using a multilayer disc having two or more layers, when adjustment is NG on the second L1 layer, or the third L2 layer, . . . , or the N-th L(N−1) layer, the disc may be treated as a single-layer disc having the first L0 layer, or a two-layer disc having the first L0 layer and the second L1 layer, or a (N−1)-layer disc having the first L0 layer, the second L1 layer, and the (N−1)th L(N−2) layer, respectively.

Further, this information is stored in a “layer-basis learning result area”, and the disc is managed according to the stored result such that recording is performed by only the first layer while reproduction is performed by both the first and second layers. Accordingly, when time-shift recording is made on a BD disc, this time-shift recording can be executed without any trouble up to a record time of the same capacity as the single-layer disc.

Further, a player for reproduction only reads the layer-basis learning result area, and treats the disc as a single-layer disc if the learning of the focus position and the spherical aberration has failed in the second layer, and thus the player can easily handle the optical disc.

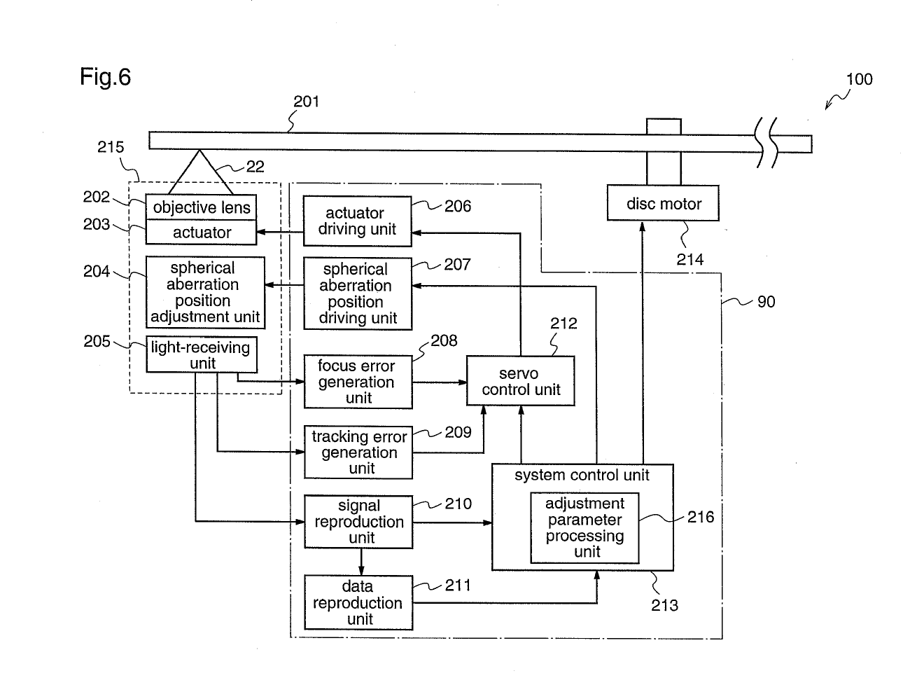

Next, a description will be given of the optical disc device of the first embodiment of the present invention which concretely realizes the above-described configuration. FIG. 6 is a block diagram illustrating the configuration of the optical disc device 100 of the first embodiment.

The optical disc device 100 shown in FIG. 6 is provided with a disc motor 214 which rotates a loaded optical disc 201, an optical pickup 215 which optically accesses the optical disc 201, and a circuit part 90 which performs exchange of signals with the optical pickup 215.

The optical pickup 215 is provided with an objective lens 202 which converges a light beam 22 emitted from a laser light source (not shown) onto the optical disc 201, and a light-receiving unit 205 which receives the light beam 22 reflected at the optical disc 201 and converts the same into various electric signals. A spherical aberration position adjustment unit 204 is disposed between the objective lens 202 and the light receiving unit 205. The spherical aberration position adjustment unit 204 is a device having an aberration correction lens which is movable in the light axis direction (refer to FIG. 5), and it adjusts the focusing and diverging state of the light beam 22 to reduce the aberration of the light beam 22 on the information layer in the optical disc 201.

The electric signal outputted from the light-receiving unit 205 is supplied to a focus error generation unit 208, whereby a focus error signal (FE signal) is generated. Likewise, the electric signal outputted from the light-receiving unit 205 is supplied to a tracking error generation unit 209 and to a signal reproduction unit 210, whereby a tracking error signal (TE signal) and a reproduction signal (RF signal) are generated, respectively. The RF signal is supplied to a data reproduction unit 211, and the data reproduction unit 211 decodes the data recorded in the optical disc 201 on the basis of the RF signal to send the decoded data to a system control unit 213. The system control unit 213 calculates values to be indexes for reproduction of user's data and signal qualities such as jitter, on the basis of the signal supplied from the data reproduction unit 211.

The FE signal can be generated by a focus error detection method which is generally called an astigmatic method. Further, the TE signal can be generated by a tracking error detection method which is generally called a push-pull method. The FE signal and the TE signal are supplied to a servo control unit 212, thereby performing a focus servo control for maintaining the relative distance between the objective lens 202 and the recording surface of the optical disc 201 constant, and a tracking servo control for making the laser irradiation position follow the track on the optical disc 201. A control signal from the servo control unit 212 is supplied to an actuator driving unit 206.

The actuator driving unit 206 transfers a drive signal to an actuator 203 of the objective lens 202 which is provided in the optical pickup 215 to drive the actuator 203 of the objective lens 202. That is, the servo control unit 212 operates the actuator 203 of the objective lens 202 according to the error signals to drive the objective lens 202, whereby servo loops for a focus control and a tracking control are respectively formed and servo controls are carried out.

The spherical aberration position adjustment unit 204 changes the aberration correction amount according to the drive signal from the spherical aberration position drive unit 207, thereby to execute spherical aberration correction.

The system control unit 213 generates a triangle-wave focus up-down signal which brings the focus position of the objective lens 202 close to or apart from the optical disc 201, and transfers the signal to the servo control unit 212. The servo control unit 212 and the actuator drive unit 206 bring the focus position of the objective lens 202 close to or apart from the optical disc 201 according to the focus up-down signal. Further, the system control unit 213 makes a rotation instruction or a stop instruction to the disc motor 214, and sets the number of rotations, thereby controlling the rotation of the disc motor 214.

An adjustment parameter processing unit 216 judges the L0 layer adjustment result, i.e., as to whether the adjustment is normally completed or not, and further, it judges whether the values of the adjusted focus position and spherical aberration are appropriate or not, and then sets a status flag of inhibition or permission for recording or reproduction on the L0 layer to complete the startup of the L0 layer and continue adjustment for the L1 layer.

While in this first embodiment the adjustment parameter processing unit 216 is included in the system control unit 213, it may be included in the servo control unit 212, or it may be an independent constituent. Further, the adjustment parameter processing unit 216 may be implemented by a part of a control program which constitutes the system control unit 213 or the servo control unit 212.

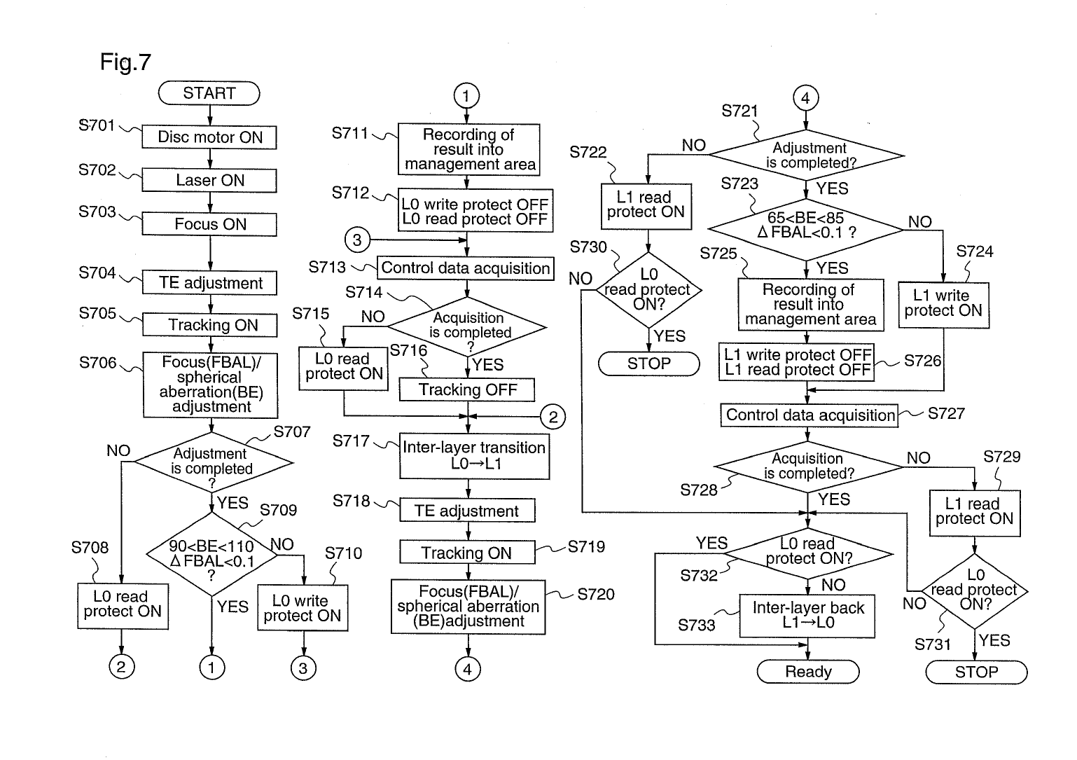

Next, the procedure for activating the optical disc 201 and the procedure for processing an adjustment error will be described with respect to the focus and spherical aberration adjustment, with reference to FIG. 7. FIG. 7 is a flowchart illustrating the procedure for activating the optical disc 201 using the optical disc device 100 of the first embodiment.

Initially, in step 701, setting of number-of-rotations and instruction for rotation start are performed from the system control unit 213 to the disc motor 214.

In step 702, irradiation of laser from a laser light source (not shown) to the optical disc 201 is started. In step 703, the servo control unit 212 enables focus servo control.

In step 704, adjustment of the TE signal is performed to optimize the amplitude and balance of the TE signal.

In step 705, tracking servo control is turned on.

In step 706, the focus position is adjusted by the actuator 203 of the objective lens 202, and the spherical aberration correction position is adjusted by the spherical aberration correction unit 204. This adjustment is one for optimizing the focusing state of the light beam 22 on the information layer, for data reproduction.

This focus position/spherical aberration correction position adjustment (FBAL/BE adjustment) is one for absorbing variation in the thickness of the light transmission layer in the optical disc 201 (100 μm±5 μm), variation in the laser wavelength, and occurrence of a spherical aberration due to variation in temperature. However, if the optical disc 201 varies more than estimated or when the usage environment is severe such as a high or low temperature, the adjusted value might be a very high value such as 110 μm in the thickness, or the quality of the TE signal, the FE signal, or the RF signal is degraded when the adjusted value fluctuates in the positive or negative direction to search for the optimum focus position or the optimum spherical aberration correction position during the actual adjustment and thereby deviation of servo occurs during the adjustment, or the current position is lost due to incapability of address reading, resulting in an adjustment error.

In step 707, it is judged whether the adjustment is normally completed or not, and if the adjustment is abended due to such as servo deviation, a flag of read protect (recording and reproduction inhibited (recording inhibited and reproduction inhibited) is set on the L0 layer (step 708).

In step 709, even when the adjustment has been normally completed, if the adjusted value is so large that a lack of margin of the recording power is sufficiently assumed, for example, if the spherical aberration is less than 90 μm or larger than 110 μm when converted into the base material thickness, a flag of write protect (recording inhibited and reproduction permitted) is set (step 710).

When the adjusted value is normal, the operation goes to step 711, wherein the learning result and the read/write protect OFF state are recorded in the “layer-basis adjustment result storage area” on the management region (step 712).

Next, in step 713, control data recorded in the optical disc 201 is obtained. For example, the control data includes the disc type, and the parameters used for recording and reproduction which are recommended by the disc maker of the disc.

In step 714, it is judged whether the control data has been obtained or not. When the control data has not been obtained, it is judged that reproduction of the data part is difficult to be ensured as in the case where the adjustment has failed, and the L0 layer is read-protected (step 715).

The L0 layer is set in the recordable state (recording permitted and reproduction permitted) without write protect when the adjustment has been normally completed, or the L0 layer is set in the reproduction-only state with write protect (recording inhibited and reproduction permitted) when the adjusted value of the spherical aberration is not within the predetermined range, or the tracking is turned off with the L0 layer being in the read protected state, i.e., in the recording and reproduction inhibited state (recording inhibited and reproduction inhibited) when an error occurs during the adjustment or the control data cannot be obtained (step 716), and then the actuator 203 and the spherical aberration position adjustment unit 204 are driven to move the light beam spot from the L0 layer to the L1 layer (step 717).

In step 718, the TE signal is adjusted to optimize the amplitude and balance thereof on the L1 layer after the inter-layer transfer.

In step 719, the tracking servo control is turned on. In step 720, as in the case of the L0 layer, the focus position is adjusted by the actuator 203 of the objective lens 202, and the spherical aberration correction position is adjusted by the spherical aberration position adjustment unit 204.

In step 721, it is judged whether the adjustment has been normally completed or not. When it is abended due to servo deviation or the like, a flag of read protect is set on the L1 layer (step 722).

Further, in step 723, even when the adjustment has been normally ended, if the adjusted value is so large that a lack of margin for the recording power is sufficiently assumed, for example, if the spherical aberration is less than 65 μm or larger than 85 μm when converted into the base material thickness, a flag of write protect is set (step 724).

When the adjusted value is normal, the operation goes to step 725, wherein the learning results of the L0 and L1 layers and the read/write protect OFF states of the L0 and L1 layers are recorded in the “layer-basis adjustment result storage area” on the management region of the L1 layer (step 726).

Next, in step 727, the control data which is also recorded in the L1 layer of the optical disc 201 is obtained.

In step 728, it is judged whether the control data has been obtained or not. When the control data has not been obtained, it is judged that not only data recording but also data reproduction are difficult to be ensured, as in the case where the adjustment has failed, and the L1 layer is read-protected (step 729).

Thereafter, in steps 730 and 731, it is judged whether the L0 layer has also been read-protected or not. When both the L0 layer and the L1 layer are read-protected, since any operation cannot be performed, a predetermined error code is sent to a host (not shown) to stop the startup.

Further, when the L1 layer is write-protected while the L0 layer is read-protected, interlayer transfer from the L1 layer to the L0 layer is not performed. When both the L1 layer and the L0 layer are normally ended or write-protected, interlayer transfer is performed to go into the stand-by state (READY) at a predetermined track, or usually, in the vicinity of address 0 (steps 732-733).

Further, the information of inhibition or permission for recording or reproduction for each layer, or the adjustment result may be recorded in a predetermined area such as the layer-basis adjustment result storage area in the optical disc.

Furthermore, when the first layer is inhibited for both recording and reproduction, an identification information that this disc is a single-layer disc with the first layer being recording and reproduction inhibited may be written in the second layer. Conversely, when the second layer is inhibited for both recording and reproduction, identification information that this optical disc is a single-layer disc with the second layer being recording and reproduction inhibited may be written in the first layer.

As described above, the optical disc device 100 of the first embodiment comprises the objective lens 202 which focuses the light beam 22, the lens actuator 203 which drives the objective lens 202, the light-receiving unit 205 which receives the light beam reflected by the optical disc 201 and converts the same into an electric signal, the control unit which perform, at startup, learning for determining the values of the first parameters that are set for recording or reproducing data in or from the first information layer and the values of the second parameters that are set for recording or reproducing data in or from the second information layer, and the management unit which performs setting and management for inhibition or permission of recording or reproduction to the respective layers including the first and second information layers. In the case of using a two-layer disc, spherical aberration correction and focus position adjustment are performed for the respective information layers, and the setting process is performed for the respective information layers such that the startup is not abended even when an error such as disc variation or defect occurs in either of the two layers while the other layer for which the adjustment is normally completed is made recordable. Therefore, the usable information layers in the large-capacity media are made to function effectively with reducing such as missing of recording time, and further, failure of program recording due to a startup error can be avoided under the situation where confirmation by human operation cannot be performed, such as time-shift recording.

In this first embodiment, the case of performing adjustment for the spherical aberration and the focus position has been described. However, in the present invention, since tilt adjustment for optimally tilting the lens against a disc warpage or drooping and TE adjustment as shown in FIG. 7 are also performed for each layer in the device startup process in addition to the adjustment for the spherical aberration and the focus position, even when these adjustments are not successful or the adjusted values are inappropriate and thereby an error occurs in some layer, only the layer having such error can be inhibited or permitted for recording or reproduction by similarly applying the first embodiment.

### Embodiment 2

The aforementioned first embodiment provides a method for resolving errors including a spherical aberration or a coma aberration that is mainly caused by the physical characteristics of the disc (i.e., variation in the layer thickness and variation in tilt), and a focus position adjustment error that depends on such aberration, which errors may occur in any one layer in a multilayer disc. On the other hand, a second embodiment of the present invention provides a method for resolving errors in recording power learning or recording compensation learning, which are mainly caused by variation in the characteristics of a recording film, which errors may occur in any one layer in a multilayer disc.

Hereinafter, an optical disc device according to the second embodiment will be described.

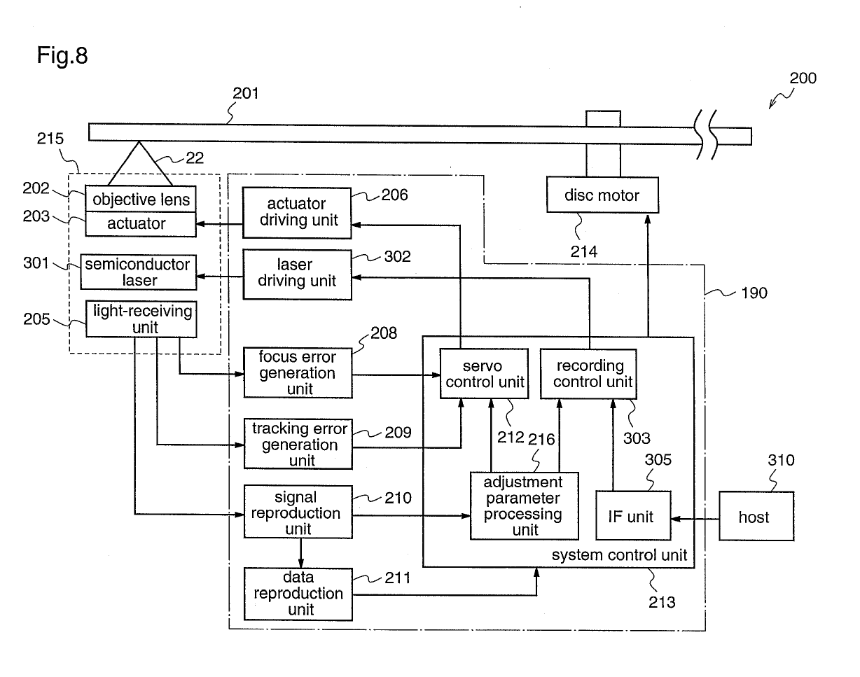

FIG. 8 is a block diagram illustrating the configuration of an optical disc device 200 of the second embodiment. In FIG. 8, the same constituents as those of the optical disc device 100 of the first embodiment shown in FIG. 6 are given the same reference numerals to omit the detailed description thereof.

The optical disc device 200 shown in FIG. 8 includes a disc motor 214 which rotates a loaded optical disc 201, an optical pickup 215 which optically accesses the optical disc 201, and a circuit part 190 which exchanges signals with the optical pickup 215.

The optical pickup 215 includes an objective lens 202 which focuses a light beam 22 emitted from a semiconductor laser 301 onto the optical disc 201, and a light-receiving unit 205 which receives the light beam 22 reflected by the optical disc 201 and converts the same into various electric signals. Further, the optical pickup 215 includes a semiconductor laser 301 which pulse-modulates data transferred from the host 310 to record the same on the optical disc 201. A semiconductor laser 301 having a plurality of wavelengths may be mounted, and the wavelengths are switched according to the optical disc 201.

The electric signal outputted from the light-receiving unit 205 is supplied to the focus error generation unit 208, whereby a focus error signal (FE signal) is generated. Likewise, the electric signal outputted from the light-receiving unit 205 is supplied to the tracking error generation unit 209 and to the signal reproduction unit 210, whereby a tracking error signal (TE signal) and a reproduction signal (RF signal) are generated, respectively. The RF signal is supplied to the data reproduction unit 211, and the data reproduction unit 211 decodes the data recorded in the optical disc 201 on the basis of the RF signal, and sends the decoded data to the system control unit 213.

The system control unit 213 includes an adjustment parameter processing unit 216, a servo control unit 212, a recording control unit 303, and an IF unit 305. The system control unit 213 modulates the data transferred from the host 310 or the video audio information into a predetermined recording signal by the recording control unit 303 through the IF unit 305.

A laser drive unit 302 controls the semiconductor laser 301 on the basis of the recording signal from the recording control unit 303 to adjust the recording power. The semiconductor laser 301 forms recording marks on the tracks of the optical disc 201 with using the adjusted recording power.

As for the recording system, a write-once system to an organic dye film which is represented by CD-R and DVD-R and a rewritable system to a phase change film which is represented by DVD-RW and DVD-RAM are popular in recent years.

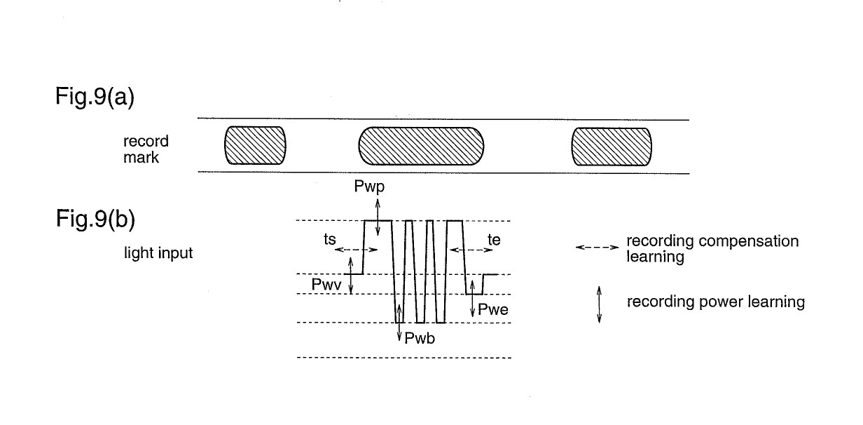

The recording signal has a light output power as shown in FIG. 9(b), and the semiconductor laser 301 realizes the required number of pulses, pulse height, and pulse width according to the lengths of write signal marks which are uniformly determined by the modulation mode, for example, the lengths of signal marks ranging from 3 T to 14 T for 8-16 modulation in the case of DVD, under control of the laser drive unit 302 and the recording control unit 303, and forms the signal marks on the track as shown in FIG. 9(a).

The optical disc device 200 performs recording power learning for learning a peak power Pwp, a bottom power Pwb, a bias power Pwv, and an erase power Pwe which are the parameters of the recording power as shown in FIG. 9 so as to optimize these parameters, so that optimum recording can be realized by performing test recording at startup in order to accurately perform recording, i.e., in order to form signal marks, even when there exist a spherical aberration caused by variations in the characteristics of the recording film or variations in the optical pickup including the semiconductor laser 301, a coma aberration or a surface vibration caused by a disc tilt, and a focus deviation caused by temperature change, and furthermore, the optical disc device 200 performs recording compensation learning for learning a head pulse width ts and an end pulse width to so as to optimize these pulse widths.

Various methods have been executed as methods for learning and correction. For example, there is a method including reading the recording conditions that have previously been written by the disc maker, performing several times of test recordings using the read values as reference values, measuring the amplitude and jitter of the recorded signal for each recording by the signal reproduction unit 210 and the adjustment parameter processing unit 216, and repeating the process with varying the power so as to optimize the measured values. Likewise, as for the recording compensation learning, there is a method including reading the recording conditions which have previously been written by the disc maker, performing several times of test recordings using the read values as reference values, measuring the amplitude and jitter of the recorded signal for each recording by the signal reproduction unit 210 and the adjustment parameter processing unit 216, and repeating the processing with varying the power so as to optimize the measured values. However, the details of these methods will be omitted.

In the case of using a double or multiple layer disc, since the respective layers have different characteristics of recording films, the respective layers are previously accessed at startup to perform test recording and learning, and thereafter, data recording is started according to the respective operations, for example, video recording and dubbing for a recorder, or storage and overwriting for a PC.

That is, in the case of the two-layer disc, test recording is performed on the L0 layer and recording power learning is performed so as to optimize the peak power Pwp and the bottom power Pwb which are the recording powers, and then recording compensation learning or correction is performed so as to optimize the head pulse width ts and the end pulse width te, and thereafter, inter-layer transfer is performed to the L1 layer. Also on the L1 layer, test recording is performed, and recording power learning is performed so as to optimize the peak power Pwp and the bottom power Pwb which are the recording powers, and thereafter, recording compensation learning or correction is performed so as to optimize the head pulse width ts and the end pulse width te.

If, on the L0 layer, a servo error such as track jump or focus deviation has occurred during the test recording, or the learned power value or the recording compensated value is converged to a larger value or a smaller value than a predetermined value, the adjustment parameter processing unit 216 judges the adjustment result obtained in the L0 layer, i.e., whether the adjustment has been normally completed or not and whether the adjusted recording power and recording compensated value are appropriate or not, and sets a status flag of inhibition or permission for recording or reproduction on the L0 layer to complete the startup of the L0 layer, and then continues the startup adjustment process for the L1 layer. The error processing in the recording learning for the L1 layer is similarly carried out.

While in this second embodiment the adjustment parameter processing unit 216 is included in the system control part 213, the adjustment parameter processing unit 216 may be included in the servo control unit 212, or it may be an independent constituent.

Further, the adjustment parameter processing unit 216 may be implemented by a part of a control program which constitutes the system control part 213 or the servo control part 212.

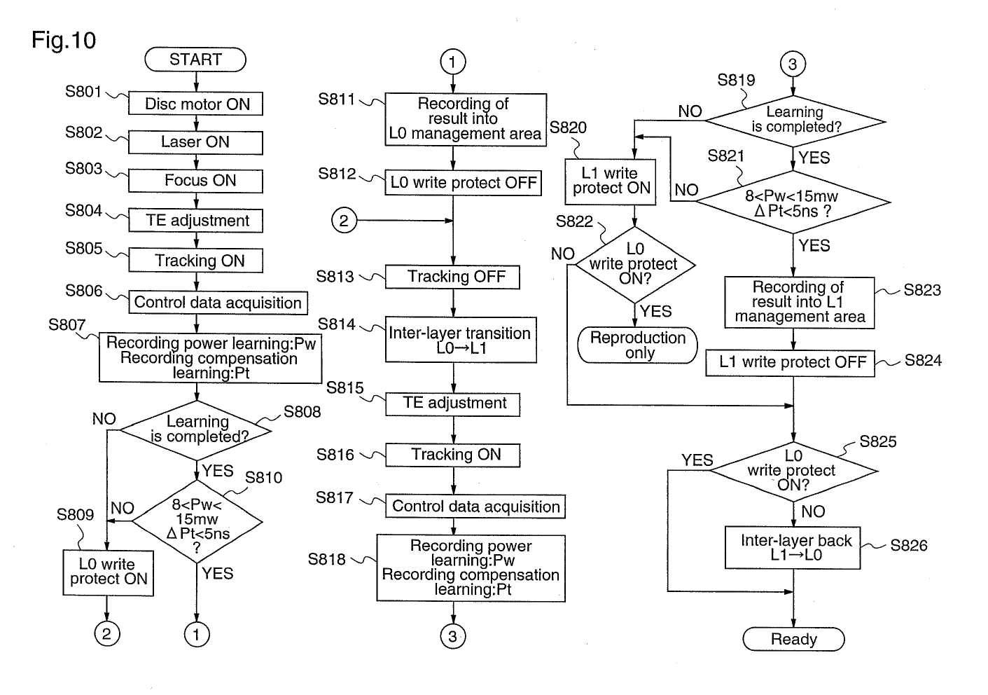

Next, the startup procedure for the optical disc 201 and the procedure for treating an adjustment error will be described with respect to the recording power learning and the recording compensation learning with reference to FIG. 10.

FIG. 10 is a flowchart illustrating the procedure for activating the optical disc 201 using the optical disc device 200 of the second embodiment.

Initially, in step 801, the system control part 213 sets the number of rotations, and instructs the disc motor 214 to start rotation.

In step 802, the semiconductor laser 301 in the laser light source starts to emit laser onto the optical disc 201.

In step 803, the servo control unit 212 enables focus servo control.

In step 804, tracking servo control is turned on.

In step 805, a control track which is usually positioned on the inner circumference is accessed. In step 806, control data recorded in the optical disc 201 are obtained.

The control data include, for example, the disc type and the parameters used for recording and reproduction, which are recommended by the disc maker, and the recording power and the recording compensation value among the parameters are read out to be used as initial values for recording power learning and recording compensation learning in the next step.

In step 807, test recording is performed with the pickup being moved to a PCA (Power Calibration Area) positioned in the vicinity of the area where the control data exist, and then a set of recording power learning and recording compensation learning are executed.

In step 808, it is judged whether the respective learnings are normally completed or not, and if the recording learning is not normally completed due to focus jump or track flow during the learning, the operation goes to step 809 to set write protect of the L0 layer.

In step 810, in the case where the usage environment is severe such that high or low temperature or the disc film is degraded due to repetition or aging, it is judged that normal recording cannot be performed when the adjusted value is converged to a value having a power not less than 15 mW or not larger than 8 mW in a two-layer BD or when the start or end pulse width becomes an impossible value such as 5 ns or less, and then the operation goes to step 809 to set write protect on the L0 layer.

When the recording learning on the L0 layer is normally completed and the learned value is converged within a predetermined range, the result is recorded in the management area in steps 811 and 812, followed by a startup process for the next L1 layer.

Although the result cannot written in the management area when the learning is abended, the information as to whether the L0 layer is write protected or not is managed by the system control unit 213.

Next, in step 813, the tracking control is turned off. In step 814, interlayer transfer from the L0 layer to the L1 layer is carried out.

After the transfer to the L1 layer, the tracking servo control is turned on in step 815.

In step 816, the control track located at a predetermined position in the L1 layer is accessed. In step 817, the control data recorded in the optical disc 201 are obtained.

The control data include, for example, the disc type and the parameters used for recording and reproduction, which are recommended by the disc maker, and the recording parameters of the L1 layer among the parameters, i.e., the power and the recording compensation value, are read out to be used as initial values for recording power learning and recording compensation learning in the next step.

There is the case where the recording parameters of both the L0 and L1 layers are written in the control track of the L0 layer. In this case, it is not necessary to again obtain the recording parameter as the control data in the L1 layer.

In step 818, test recording is carried out with the pickup being moved to the PCA (Power Calibration Area) positioned in the vicinity of the area where the control data exist, and a set of recording power learning and recording compensation learning are performed.

Similarly to the L0 layer, in step 819, it is judged whether the respective learnings are normally ended or not, and if the recording learning is not normally ended due to focus jump or track flow, the operation goes to step 820 to set write protect on the L1 layer.

In step 821, in the case where the usage environment is severe such as low or high temperature or the disc film is deteriorated due to repetition or aging, it is judged that normal recording cannot be carried out when the adjusted value is converged to a value having a power not less than 15 mW or not larger than 8 mW in a two-layer BD or when the adjusted value is converted to an impossible value such as a start or end pulse width not larger than 5 ns, and then the operation goes to step 820 to set write protect on the L1 layer.

In step 822, when it is judged that the L0 layer is also write-protected in the system control unit 213, the optical disc 201 is firstly set as a disc for reproduction only.

When the L0 layer is not write-protected, interlayer transfer from the L1 layer to the L0 layer is made in step 826, and the pickup stands by in a predetermined area of the L0 layer, usually, track address 0.

When the recording learning for the L1 layer is normally ended and the learned value is converged within a predetermined range, the result is recorded in the management area of the L1 layer in step 823, and it is set in step 824 that the L1 layer is recordable, and then it is judged in step 825 whether the L0 layer is write-protected or not.

When it is judged by the system control part 213 that the L0 layer is write-protected, interlayer transfer is not carried out, and the pickup stands by in a predetermined area on the L1 layer, e.g., a track corresponding to the start address of the L1 layer.

Further, as a process common to the first and second embodiments, control data in a control track which is arranged in a predetermined area at the inner circumference of the disc are read out.

Since this control data includes important information for recording the disc, if the control data cannot be read or the control track itself cannot be accessed, at least write protect may be set on the layer.

Further, the information of inhibition or permission for recording or reproduction for each layer or the adjustment result may be recorded in a predetermined area such as a layer-basis adjustment result storage area of the optical disc.

Further, when the first layer is inhibited for both recording and reproduction, identification information that the optical disc is a single-layer disc with the first layer being inhibited for recording and reproduction may be recorded in the second layer. Conversely, when the second layer is inhibited for both recording and reproduction, identification information that the optical disc is a single-layer disc with the second layer being inhibited for recording and reproduction may be recorded in the first layer.

As described above, the optical disc device 200 of the second embodiment comprises the objective lens 202 which focuses the light beam 22, the lens actuator 203 which drives the objective lens 202, the light-receiving unit 205 which receives the light beam reflected by the optical disc 201 and converts the light beam into an electric signal, the control unit which performs, at startup, learning for determining the values of the first parameters that are set for recording or reproducing data in or from the first information layer and the values of the second parameters that are set for recording or reproducing data in or from the second information layer, and the management unit which performs setting and management of inhibition or permission for recording or reproduction to the respective layers including the first and second information layers. When the optical disc 201 is a two-layer disc, recording power learning and recording compensation learning are performed for each of the L0 layer and the L1 layer, and the setting process is performed for the respective information layers such that the startup is not abended even when an error occurs in either of the two layers due to variations in film characteristics, aging, or temperature environment, while the other layer for which the adjustment is normally completed is made recordable. Therefore, the usable information layers in a large-capacity media are made to function effectively with reducing such as missing of recording time, and further, failure of program recording due to a startup error can be avoided in the situation where confirmation cannot be performed by human operation, such as time-shift recording.

Further, while in the first and second embodiment a two-layer disc is adopted as a specific example, a multilayer disc having more than two layers may be similarly treated. Hereinafter, control for recording and reproduction of a multilayer disc having M (M≧2) layers will be described with reference to FIG. 21.

FIG. 21 shows a six-layer optical disc 1003 comprising L0 to L5 layers. In the optical disc 1003 shown in FIG. 21, flags are set on layers which are subjected to learning for determining the values of the above-mentioned parameters. The flags are not necessarily set on all the layers, but are set on R (M≦R) pieces of layers. In FIG. 21, flags are set on four layers L0 to L3.

First of all, the L0 to L3 layers are subjected to learning for determining the values of the parameters which are set for recording and reproducing data. Since the learning method is similar to the above-described method for the two-layer disc, repeated description is not necessary. Next, a flag of reproduction permission or recording permission is set on the layers for which the values of the parameters are determined, while a flag of reproduction inhibition or recording inhibition is set on the layers for which the values of the parameters cannot be determined. FIG. 21 shows the state where the flag of reproduction permission and recording permission is set on the L0 layer and the L2 layer, the flag of reproduction inhibition and recording inhibition is set on the L1 layer, and the flag of reproduction permission and recording inhibition is set on the L3 layer.

Next, logical addresses are assigned to only the recordable or reproducible layers. For example, in FIG. 21, when reproducing the optical disc 1003, since the L1 layer is not reproducible, successive logical addresses are assigned to the L0, L2, L3, L4, and L5 layers in this order. Similarly, when recording the optical disc 1003, since the L1 layer and the L3 layer are not recordable, successive logical addresses are assigned to the L0, L2, L4, and L5 layers in this order.

Further, the logical addresses may be assigned to the L4, L5, L0, and L2 layers in this order when performing recording, while the logical addresses may be assigned to the L4, L5, L0, L2, and L3 layers in this order when performing reproduction. That is, since the L4 and L5 layers are always recordable and reproducible, the logical addresses are firstly assigned to these layers. Since the L0 to L3 layers might become unrecordable or unreproducible depending on the situation, the logical addresses later than those assigned to the L4 and L5 layers are assigned thereto. With respect to the order of the L0 to L3 layers, the layers which are recordable and reproducible are firstly given the logical addresses, and thereafter, the layers which are unrecordable but reproducible are given the logical addresses. There is substantially no layer which is recordable but unreproducible.

By performing ordering such that the layers with no flags are assigned the logical addresses prior to the layers with flags, even when the states of the flags are changed later, the layers with no flags can be accessed with the same logical addresses as ever because the logical addresses of the layers with no flags are not changed, while reassignment of logical addresses is required for the layers with flags.

Furthermore, when a layer which is unrecordable but reproducible is present, ordering is performed such that this layer is assigned a logical address after a layer which is recordable and reproducible, whereby a difference in the logical address does not occur between the recording and reproduction device and the reproduction-only device. The flag of inhibition or permission for recording or reproduction may be written in any area on the optical disc. The information of the respective layers may be collectively written on a certain layer.

As described above, in the M-layer (M≦2) disc, flags are set on R (R≦M, R≧1) pieces of layers, and when N (N≦R) pieces of layers are NG, flags of reproduction and recording inhibition are set on the NG layers to hide the NG layers, and thus the M-layer disc is controlled as a (M−N) layer disc. In FIG. 21, the optical disc 1003 is controlled as a five-layer disc during reproduction while it is controlled as a four-layer disc during recording.

### Embodiment 3

Another optical disc device can identify the optical disc produced by the optical disc device of the first or second embodiment by reading out the information of inhibition or permission for recording or reproduction for each layer, which is recorded in the optical disc. Hereinafter, a third embodiment of the present invention will be described.

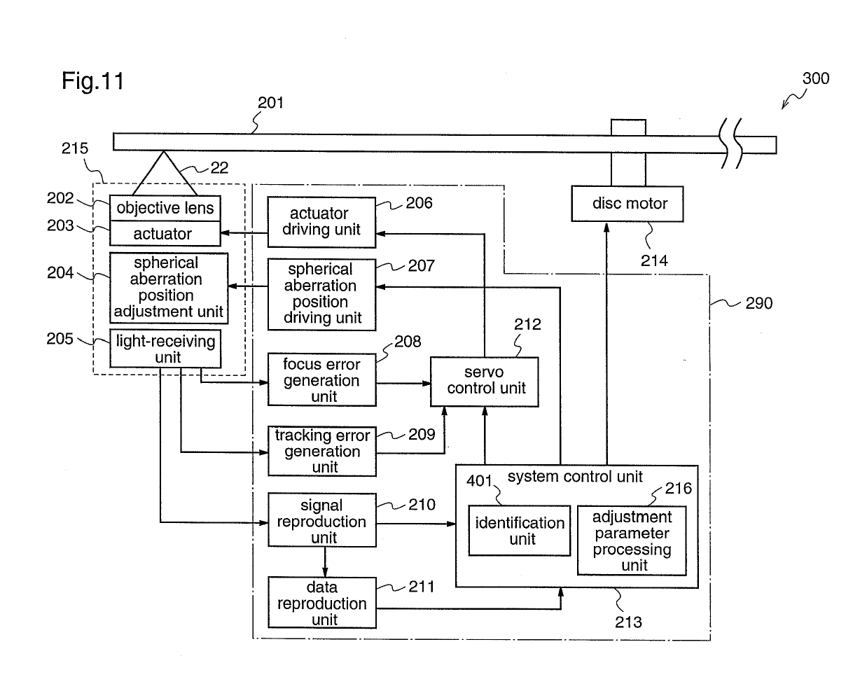

FIG. 11 is a block diagram illustrating the configuration of an optical disc device 300 of the third embodiment. In FIG. 11, the same constituents as those in FIG. 6 which shows the configuration of the optical disc device 100 of the first embodiment are given the same reference numerals to omit the description thereof.

Hereinafter, the third embodiment will be described with reference to FIG. 11.

The optical disc device 300 of the third embodiment shown in FIG. 11 has an identification unit 401 in the system controller 213, in addition to the constituents of the first embodiment shown in FIG. 6. In FIG. 11, reference numeral 290 denotes a circuit part for exchanging signals with the optical pickup 215, which is provided instead of the circuit part 90 of the first embodiment shown in FIG. 6.

The identification unit 401 identifies the optical disc 201 on the basis of the information of inhibition or permission for recording or reproduction for each layer, which is recorded in the optical disc 201 and read out by the signal reproduction unit 210 or the data reproduction unit 211.

For example, when information indicating that the second layer L1 is unrecordable and unreproducible (recording inhibited and reproduction inhibited) is read out from the two-layer disc, the optical disc 201 is identified as a single-layer disc.

Further, an reproduction-only optical disc device or the like can smoothly perform reproduction by identifying the optical disc 201 as a single-layer disc based on the above-mentioned information even if the disc is actually a two-layer disc.

Further, even if the optical disc 201 is actually an M (M≧2)-layer disc, the optical disc 201 is identified as a (M−N) layer disc when information indicating that N (M>N) pieces of layers among the M pieces of layers are unrecordable and unreproducible (recording inhibited and reproduction inhibited) is read out.

Further, a reproduction-only optical disc device or the like can smoothly perform reproduction by identifying the optical disc as an (M−N) layer disc on the basis of the above-mentioned information even if the disc is actually an M-layer disc.

Furthermore, while identification of the optical disc is usually performed using a focus error signal (FE signal), identification may be performed using the above-mentioned information for preference, without believing the FE signal. As the result, recording and reproduction can be easily performed.

As described above, the optical disc device 300 of this third embodiment further includes the identification unit 401 which identifies an optical disc fabricated by another optical disc device, and the identification unit 401 reads out and identifies the values of each layer including the first and second parameters and the result of determination as to whether the values are available or not, which are recorded in a predetermined area of the optical disc, or the information of inhibition or permission for recording or reproduction for each layer, which is recorded on a predetermined area of the optical disc. Therefore, the optical disc device 300 is allowed to have compatibility with other optical disc devices, and thus it can effectively perform recording and reproduction to the optical disc.

### Embodiment 4

When an optical disc is formed by the optical disc device according to any of first, second, and third embodiments, recording inhibition setting for each layer may be recorded on the disc (reproduction permission setting may be recorded), and further, if the optical disc is a write-once optical disc, a disc formation completion process (hereinafter referred to as “finalization”) may be performed as an additional process by recording such as NULL (zero) data in an unrecorded area of the disc so as to make the optical disc reproducible by another optical disc device. Hereinafter, a fourth embodiment will be described.

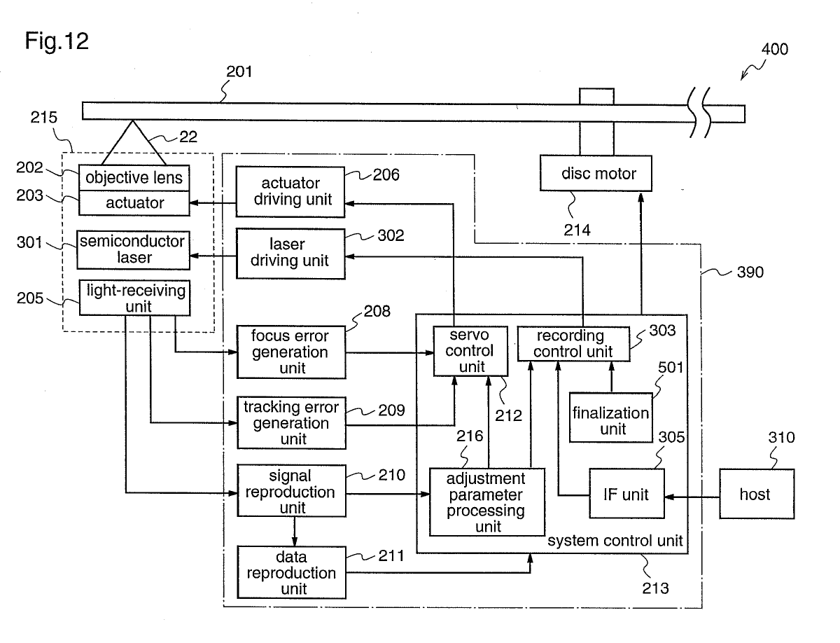

FIG. 12 is a block diagram illustrating the configuration of an optical disc device 400 of the fourth embodiment. The same constituents as those in FIG. 8 which shows the configuration of the optical disc device 200 of the second embodiment are given the same reference numerals to omit the description thereof.

Hereinafter, the fourth embodiment will be described with reference to FIG. 12.

The optical disc device 400 of the fourth embodiment shown in FIG. 12 has a finalization unit 501 in the system controller 213, in addition to the constituents of the second embodiment shown in FIG. 8. In FIG. 12, reference numeral 390 denotes a circuit part for exchanging signals with the optical pickup 215, which is provided instead of the circuit part 190 of the second embodiment.

The finalization unit 501 performs finalization for the optical disc 201 via the recording control unit 303.

There may also arise a problem as to whether finalization can be performed when a recording error occurs. In this fourth embodiment, however, since finalization is performed by only embedding NULL data regardless of the recording quality, the recording quality may be low.

As described above, the optical disc device 400 of the fourth embodiment includes the finalization unit 501 which performs a process for finalizing formation of a write-once optical disc, and the finalization unit 501 performs finalization by embedding arbitrary data in an unrecorded area of the write-once optical disc, as an additional process to setting of recording inhibition (setting of reproduction permission may be performed) in the optical disc device. Therefore, when reproducing the disc after fabricated or when reading the disc using another reproduction-only optical disc device, readout can be reliably performed. In the disc after finalized, the FE signal and the TE signal are stable because the recorded area and the unrecorded area are not mixed, and thereby reproduction compatibility can be easily ensured.

As a method for recording or reproducing an optical disc which is formed or identified by the optical disc device according to any of the first to fourth embodiments, seamless recording or reproduction may be performed by executing interlayer jumping such that N pieces of middle layers are skipped at once when it has previously been known that some middle layers in a multilayer media having three or more layers are in the recording/reproduction inhibited states, whereby the large-capacity media can be effectively recorded or reproduced.

Further, as a method for recording or reproducing an optical disc which is formed or identified by the optical disc device according to any of the first to fourth embodiments, a logical address (LA) at the head of the second layer may be treated as zero which is the start address of a two-layer disc when the two-layer disc is identified as a single-layer disc using only the second layer, and conversely, a logical address at the end of the first layer may be treated as the final logical address of a two-layer disc when the two-layer disc is identified as a single-layer disc using only the first layer. Thereby, the large-capacity media can be smoothly and effectively recorded or reproduced.

Further, not only the two-layer disc but also a multilayer disc having more than two layers can be similarly treated. For example, when an M-layer disc is controlled as an (M−N) layer disc (M>N), a logical address at the head of a (M−N) layer may be treated as zero which is a start address of the disc, and conversely, a logical address at the end of the (M−N) layer may be treated as a final logical address of the disc. Further, the optical disc can be similarly treated when recording the parameters such as the spherical aberration in a predetermined area of the disc, or when N pieces of layers are NG and therefore identification information which identifies the disc as an (M−N) layer disc having the N pieces of layers being hidden is recorded in any layer among the remaining (M−N) layers.

Further, while in the first and second embodiments an optical disc device capable of recording and reproduction is assumed, also an optical disc device for reproduction only can perform similar operation.

To be specific, while the optical disc device capable of recording and reproduction is provided with the management unit which performs setting and management of inhibition or permission for recording or reproduction for each layer, the optical disc device for reproduction only is provided with the management unit which performs setting and management of reproduction permission or reproduction inhibition for each layer, whereby the management unit performs setting of reproduction permission or reproduction inhibition for each layer.

However, the optical disc device for reproduction only cannot perform a control associated with recording to the optical disc.

Also in this third embodiment, the optical disc device for reproduction only can reads and identifies the information of reproduction permission or reproduction inhibition for each layer which is recorded on an optical disc formed by the optical disc device according to any of the first and second embodiments.

### Embodiment 5

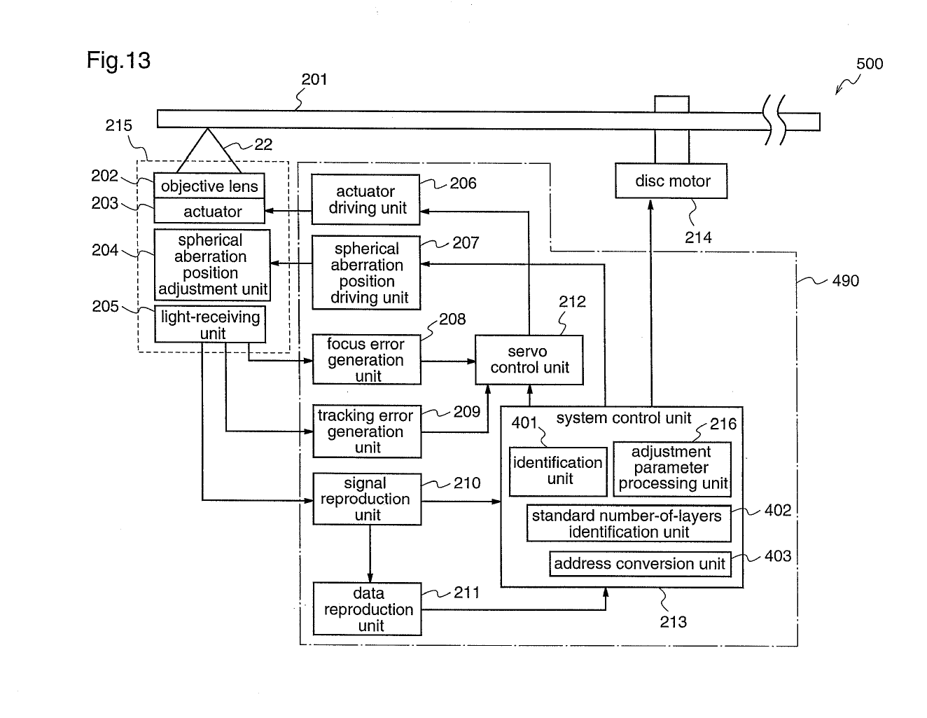

FIG. 13 is a block diagram illustrating the configuration of an optical disc device 500 according to a fifth embodiment of the present invention. The same constituents as those shown in FIG. 11 which shows the configuration of the optical disc device 300 of the third embodiment are given the same reference numerals to omit the description thereof.

Hereinafter, the fifth embodiment will be described with reference to FIG. 13.

The optical disc device 500 shown in FIG. 13 includes a standard number-of-layers identification unit 402 and an address conversion unit 403, in addition to the constituents of the third embodiment shown in FIG. 11. In FIG. 13, reference numeral 490 denotes a circuit part for exchanging signals with the optical pickup 215, which is provided instead of the circuit part 290 of the third embodiment shown in FIG. 11.

In this fifth embodiment, assuming that degradation of yield might occur due to lamination of plural layers, an optical disc having laminated plural layers including spare layers is also a subject of the invention.

Further, all the optical discs manufactured according to the contents described in the first to fourth embodiments are also subjects of the invention.

Hereinafter, a description will be given of the case where, for example, a five-layer optical disc, i.e., a four-layer optical disc based on the standard or specification to which one layer is added as a spare, is fabricated to be used.

The standard number-of-layers identification unit 402 identifies that the five-layer optical disc is a four-layer optical disc based on the standard or specification.

As for the identification method, information recorded in the optical disc may be read out to be identified. In this case, the actual number of layers including the number of spare layers, and the number of layers determined in the standard or specification may be separately recorded in the optical disc. Further, if possible, identification may be performed using the above-described focus error signal (FE signal).

Similarly to the third embodiment, the identification unit 401 identifies the optical disc 201 on the basis of the information of inhibition or permission for recording or reproduction for each layer, which is recorded in the optical disc 201 and read out by the signal reproduction unit 210 or the data reproduction unit 211, and when the identification unit 401 reads out the information that one of the five layers is inhibited for both recording and reproduction, the optical disc 201 is treated as a four-layer disc based on the information from the standard number-of-layers identification unit 402. In this way, when one of the five layers which physically exist is in its unrecordable state (defective) regardless of whether it is reproducible or not, the optical disc is treated as a four-layer disc except the defective one layer.

For the user of the optical disc 201 who is strict to the standard or specification, the optical disc 201 may be treated as a four-layer disc based on the standard or specification even when all the five layers have no problem, or it may be treated as unusable if only three layers can be normally recorded or reproduced. In this case, the quality of the standard or specification can be ensured.

The above-mentioned identification of the optical disc 201 by the identification unit 401 may be executed during the optical disc manufacturing process, and the identification result may be previously recorded in the optical disc 201. For example, in the optical disc manufacturing process, the information of inhibition or permission for recording or reproduction of each layer may be written in the disc information storage area on the optical disc 201.

When reproducing or recording such optical disc 201, the identification unit 401 may be configured so as to perform identification by reading out the information of inhibition or permission for recording or reproduction of each layer from the disc information storage area on the optical disc 201. Thereby, the optical disc 201 can be used as a disc having the specified number of logical layers or the standard number of layers in a relatively short time after insertion of the optical disc 201 into the optical disc device.

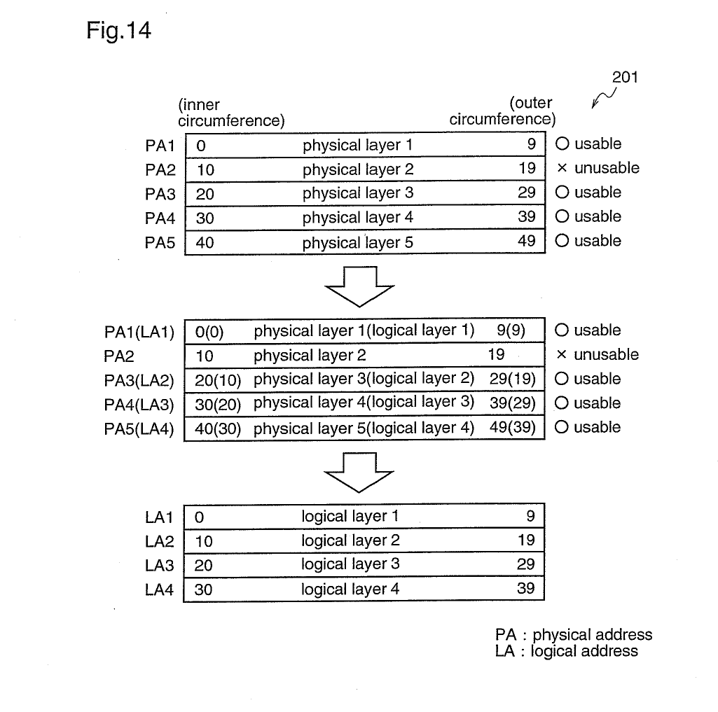

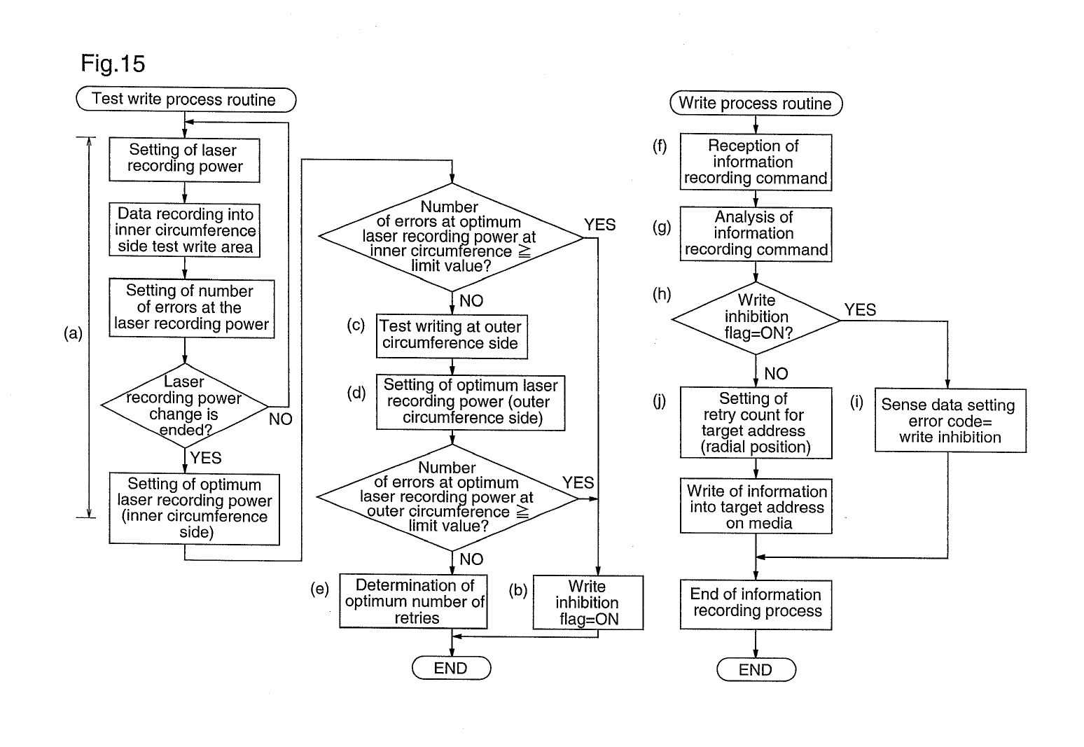

When the optical disc 201 is treated as a four-layer disc because one of the five layers is incapable of recording and reproduction, for example, when the physical layer 2 among the physical layers 1 to 5 is unusable as shown in FIG. 14, the physical layers 1 and 3 to 5 having the discontinuous address spaces are assigned as the logical layers 1 to 4 having the continuous address spaces which can be recognized by the host or the user. When data recording/reproduction to an arbitrary address is requested by the host, the address conversion unit 403 performs address conversion from the continuous address spaces of the logical layers 1 to 4 which can be recognized by the host to the discontinuous address spaces of the physical layers 1 and 3 to 5. Thereafter, the objective lens 202 and the like are operated via the servo control unit 212 to make an access to the target physical address space, and desired data are recorded/reproduced. As an example of a specific process for address conversion, one physical layer and one logical layer are made to have the same number of addresses, such as ten, and when the physical layer 2 is unusable, the head address 10 of the physical layer 2 is firstly stored.

Although the number of addresses per layer is usually much larger than 10, since there is no limitation on the numerical range in executing the invention, this fifth embodiment will be described with the number of address per layer being 10. Further, although the numbers of addresses in the respective layers are usually the same if the respective layers have the same configuration, the numbers of addresses in the respective layers are not necessarily the same. When address 25 of the logical layer is requested from the host, this address is compared with the stored head address 10 of the physical layer 2, and when the requested address is 10 or larger, an operation of adding 10 to the requested address 25 to convert the address 25 into address 35 of the physical layer 3.

Further, when address 5 of the logic layer is requested by the host, this is compared with the stored head address 10 of the physical layer 2, and if the requested address is less than 10, the requested address 5 is converted as it is as address 5 of the physical layer 1.

The above-described address conversion method is merely an example. The information about the physical or logical head addresses in the address conversion process may be tabulated to be included in the disc or the optical disc device. The algorithm of any address conversion method may be used so long as the address conversion is correctly performed from the addresses of the logical layers which are the numbers assigned to only the layers to be actually used for recording or reproduction into the addresses of the physical layers which are the numbers assigned to the layers that physically exist in the disc and also include the layers that are not actually used for recording or reproduction.

As described above, the optical disc device 500 of the fifth embodiment further includes the standard number-of-layers identification unit for identifying the number of information layers which is determined in the standard or specification for the optical disc, and uses only the standard number of information layers which are identified by the standard number-of-layers identification unit. Therefore, even when an unusable layer occurs in a new optical disc due to such as recording inhibition, the spare information layer in the optical disc can be used to provide the user with the number of layers determined in the standard or specification, and thus the optical disc can be effectively recorded and reproduced.

Further, the optical disc device 500 of this fifth embodiment further includes the address conversion unit for performing address conversion from the continuous logical addresses into the discontinuous physical addresses by using only the information layers of the number that is actually determined in the standard. Therefore, when an unusable layer occurs in the optical disc having the plural layers, address mapping which becomes physically discontinuous due to the unusable layer is converted into continuous logical address mapping, whereby the user can treat the optical disc as an optical disc having the capacity based on the standard, without being conscious of the number of the physical layers or which layer is defective.

Further, when an optical disc which is obtained by laminating a plurality of information layers including a first information layer and a second information layer and a plurality of spare information layers is used in the optical disc device 500 of this fifth embodiment, the optical disc can be recorded or reproduced as an optical disc based on the standard or specification even if an usable layer occurs. Thereby, a reduction in yield during manufacturing of the optical disc having plural layers, which is an obstacle to spreading of the optical disc, can be substantially resolved to enhance the productivity of the optical discs.

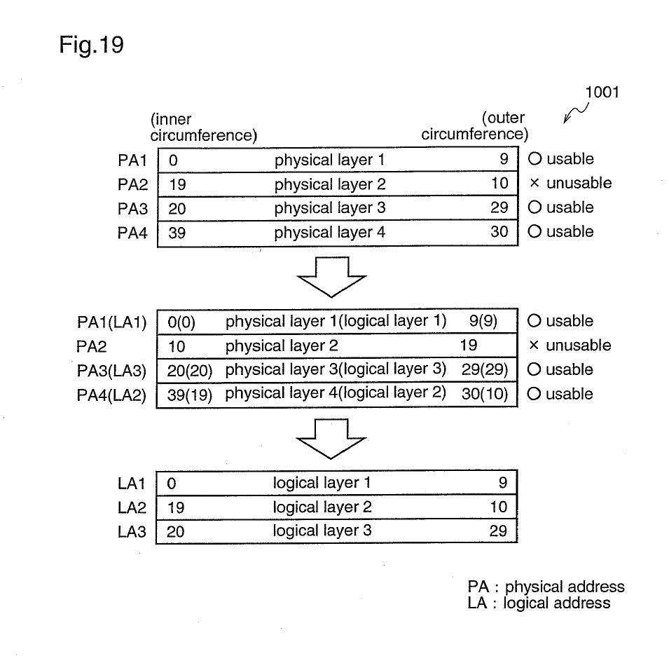

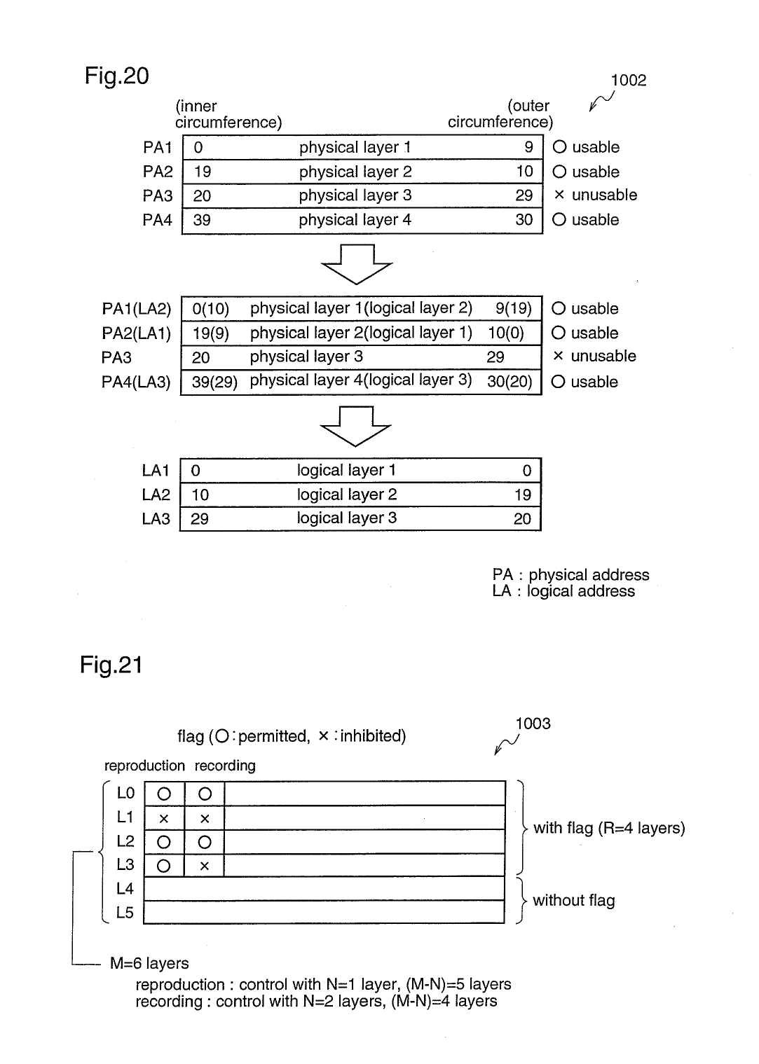

The above-described optical disc having the physical layers larger in number than the standard number of layers is assumed to have parallel track paths (the direction of recording or reproduction of all the information layers is unified to either of “from the inner circumference to the outer circumference” or “from the outer circumference to the inner circumference”). However, even when the optical disc has opposite track paths (the direction of recording or reproduction of the respective layers is alternately changed between “from the inner circumference to the outer circumference” and “from the outer circumference to the inner circumference”), it is possible to similarly provide an optical disc having physical layers larger in number than the standard number of layers. Next, an example of an optical disc having physical layers larger in number than the standard number of layers, which has the opposite track path structure, will be described with reference to FIGS. 19 and 20.

In FIG. 19, an optical 1001 is an example of a multilayer optical disc having the opposite track path structure. A physical layer 1 has a track path “from the inner circumference to the outer circumference”, a physical layer 2 has a track path “from the outer circumference to the inner circumference”, a physical layer 3 has a track path “from the inner circumference to the outer circumference”, and a physical layer 4 has a track path “from the outer circumference to the inner circumference”. FIG. 19 shows the case where the physical layer 2 is unusable (defective) for the reason such as recording inhibition, and hereinafter, a method of treating the physically four-layer disc as a logically (on the standard) three-layer disc will be described. Initially, when the physical layer 2 (having the track path “from the outer circumference to the inner circumference”) is unusable, this disc should be treated as a disc in which the layers of the track path “from the outer circumference to the inner circumference” are less in number than the layers of the track path “from the inner circumference to the outer circumference”. Accordingly, logical address assignment for this disc is started “from the inner circumference to the outer circumference” which is opposite to the track path “from the outer circumference to the inner circumference” of the defective physical layer 2. The physical layers 1 and 3 have the track path “from the inner circumference to the outer circumference”. Logical address assignment may be started from either of the physical layers 1 and 3, but it is started from the physical layer 1 in FIG. 19. Since logical address assignment is started from the physical layer 1, the physical layer 1 becomes a logical layer 1, and physical address 0 at the inner circumference is assigned to logical address 0, while physical address 9 at the outer circumference is assigned to logical address 9. The track path “from the outer circumference to the inner circumference” is selected next to the track path “from the inner circumference to the outer circumference”. Since the physical layer 2 is unusable (defective), the physical layer 4 is the only layer having the track path “from the outer circumference to the inner circumference” in the optical disc 1001. Accordingly, the next logical address is assigned from the physical layer 4. That is, physical address 30 at the outer circumference is assigned to logical address 10, while physical address 39 at the inner circumference is assigned to logical address 19. The track path “from the inner circumference to the outer circumference” is selected next to the track path “from the outer circumference to the inner circumference”. The remaining usable layer is only the physical layer 3, and the physical layer 3 has the track path “from the inner circumference to the outer circumference”. Accordingly, the next logical address is assigned from the physical layer 3. That is, physical address 20 at the inner circumference is assigned to logical address 20, while physical address 29 at the outer circumference is assigned to logical address 29. By performing the logical address assignment in this way, it is possible to provide a logically (as the standard) three-layer optical disc even when one layer (the physical layer 2 in this description) in the physically four-layer optical disc becomes unusable. As in the case of the parallel track path multilayer optical disc, the address conversion assignment manner (such as information about physical and logical head addresses) may be tabulated to be stored in the disc or the optical disc device, and the algorithm of any address conversion method may be used for conversion so long as the conversion from the logical addresses (the addresses assigned to the logical layers) into the physical addresses (the addresses assigned to the physical layers) is correctly carried out.

FIG. 20 shows another example of a multilayer optical disc having an opposite track path structure as in FIG. 19. While an optical disc 1002 shown in FIG. 20 has physically the same track path structure as that of the optical disc 1001 shown in FIG. 19, the physical layer 3 is unusable (defective) in the optical disc 1002 because it is incapable of recording. Hereinafter, a method of treating a physically four-layer disc as a logically (on the standard) three-layer disc in the above-mentioned case will be described. First of all, when the physical layer 3 (having the track path “from inner circumference to outer circumference”) is unusable, this disc must be treated as a disc in which the layers having the track path “from the inner circumference to the outer circumference” are less in number than the layers having the track path “from the outer circumference to the inner circumference”. Accordingly, logical address assignment to this disc is started “from the outer circumference to the inner circumference” which is opposite to the track path “from the inner circumference to the outer circumference” of the defective physical layer 3. The physical layers 2 and 4 have the track path “from the outer circumference to the inner circumference”. The logical address assignment may be started from either of the physical layers 2 and 4, but FIG. 19 shows the case where it is started from the physical layer 2. Since the logical address assignment is started from the physical layer 2, the physical layer 2 becomes a logical layer 1, and physical address 10 at the outer circumference is assigned to logical address 0 while physical address 19 at the inner circumference is assigned to logical address 9. The track path “from the inner circumference to the outer circumference” is selected next to the track path “from the outer circumference to the inner circumference”. Since the physical layer 3 is unusable (defective), the physical layer 1 is the only layer having the track path “from the inner circumference to the outer circumference” in the optical disc 1002. Accordingly, the next logical address is assigned from the physical layer 1. That is, physical address 0 at the inner circumference is assigned to logical address 10 while physical address 9 at the outer circumference is assigned to logical address 19. The track path “from the outer circumference to the inner circumference” is selected next to the track path “from the inner circumference to the outer circumference”. The remaining usable layer is only the physical layer 4, and the physical layer 4 has the track path “from the outer circumference to the inner circumference”. Accordingly, the next logical address is assigned from the physical layer 4. That is, physical address 30 at the outer circumference is assigned to logical address 20, and physical address 39 at the inner circumference is assigned to logical address 29. By performing the logical address assignment in this way, it possible to provide a logically (as the standard) three-layer optical disc even when a certain layer (the physical layer 3 in this description) in the physically four-layer optical disc becomes unusable.

While the method of treating a physically four-layer disc as a logically (on the standard) three-layer disc has been described with reference to FIGS. 19 and 20, it is similarly possible to treat a disc having physically even-numbered layers and opposite track path as a disc having logically (on the standard) “number of physical layers—1” layers. That is, according to the present invention, it is possible to provide an optical disc in which logical addresses are assigned so as not to use a certain layer in an optical disc in which plural sets of layers having different track paths are laminated (i.e., even-numbered layers).

While in the above description using FIGS. 19 and 20 any information layer may be selected to be assigned the logical addresses when there are plural information layers having the same track path (“from the inner circumference to the outer circumference” or “from the outer circumference to the inner circumference”), the selection (assignment) of the information layer can be performed so as to access the optical disc more effectively. To be specific, while it is necessary to perform a focus jump between the information layers (to adjust the focus servo to a target layer) when successively accessing the logical addresses which are continuous across the information layers, the assignment of the logical addresses should be performed so as to minimize the number of the layers to be skipped during the focus jump. Thereby, it is possible to minimize the temporal degradation of the access speed when successively accessing the continuous logical addresses across the information layer.

As described above, an optical disc having a plurality of layers in the number determined in the standard and additional spare layers (an optical disc in which the respective layers have the same track path, or an optical disc in which a certain layer among laminated plural sets of layers having different track paths) can be recorded or reproduced in the optical disc device 500. In this case, the standard number-of-layers identification unit recognizes the number of layers determined in the standard of the optical disc, and the address conversion unit performs address conversion from the logical address which is access-requested by the host device (a PC or AV encoder/decoder) into the corresponding physical address on the basis of the above-described mapping between the physical addresses and the logical addresses, thereby realizing recording or reproduction in or from a block (sector) existing in the physical address position.

While in this fifth embodiment a recordable and reproducible optical disc device is assumed, similar control can be performed for a reproduction-only optical disc device.

### Embodiment 6

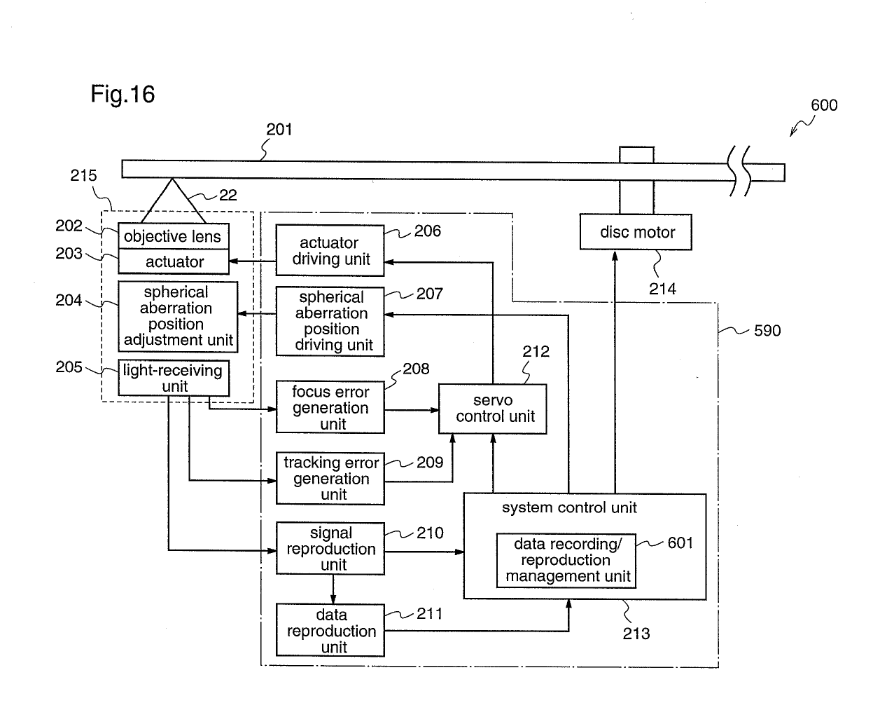

FIG. 16 is a block diagram illustrating the configuration of an optical disc device 600 according to a sixth embodiment of the present invention. The same elements as those shown in FIG. 6 which shows the configuration of the optical disc device 100 of the first embodiment are given the same reference numerals to omit the description thereof.

Hereinafter, the sixth embodiment will be described with reference to FIG. 16.

The optical disc device 600 of this sixth embodiment shown in FIG. 16 is provided with a data recording/reproduction management unit 601 in addition to the constituents of the first embodiment shown in FIG. 6. Further, the adjustment parameter processing unit 216 is dispensed with. In FIG. 16, reference numeral 590 denotes a circuit part for exchanging signals with the optical pickup 215, which is provided instead of the circuit part 90 of the first embodiment shown in FIG. 6.

In this sixth embodiment, a description will be given of the case where data are recorded in a first L0 layer or a second L1 layer in a four-layer optical disc.

When recording data in the L0 layer or the L1 layer, the data recording/reproduction management unit 601 simultaneously records the same data also in a third L2 layer or a fourth L3 layer as backup data. Therefore, even when the recording into the L0 layer or the L1 layer has failed or the recorded data cannot be reproduced for some reasons, desired data can be reproduced from the L2 layer or the L3 layer by managing the data recording position by the data recording/reproduction management unit 601, whereby the reliability of the data recording or data reproduction is enhanced.

Further, for example, by performing mirror recording to the four-layer optical disc so as to record the same data as the data recorded in the L0 layer and the L1 layer at the same address positions in the L2 layer and the L3 layer, respectively, i.e., at the addresses of the recording positions in the case where the head addresses of the respective layers are zero, management for the data recording/reproduction position is facilitated, and thereby the data can be smoothly reproduced from the third layer and the fourth layer even if the data cannot be reproduced from the first layer and the second layer for some reason.

Furthermore, when the above-mentioned mirror recording is performed during actual video recording, a temporal margin for recording the backup data can be secured by utilizing a hard disk or the like even during real-time recording. Further, even when there is no hard disk, recording of such backup data can be realized by performing high-speed recording such as 4×-speed recording.

While in this sixth embodiment a four-layer optical disc has been described, this sixth embodiment can be effectively applied to a two-layer optical disc or other multilayer optical discs.

Hereinafter, a description will be given of the case where data are recorded into a hybrid disc which is a four-layer optical disc having a plurality of information layers of different physical configurations, such as a BD disc which performs recording or reproduction using a blue-violet semiconductor laser in which two layers (L0 layer and L1 layer) among four layers have relatively short wavelengths, or a DVD disc which performs recording or reproduction using a red semiconductor laser in which two layers (L2 layer and L3 layer) among four layers have relatively long wavelengths.

When recording data in the L0 layer or the L1 layer, the data recording/reproduction management unit 601 simultaneously records the same data into the L2 layer or the L3 layer as backup data. Thereby, even when the data recorded in the L0 layer or the L1 layer cannot be reproduced for some reasons, the desired data can be reproduced from the L0 layer or the L1 layer by managing the data recording position by the data recording/reproduction management unit 601.

While a four-layer hybrid disc has been described above, the sixth embodiment is applicable to and effective for a two-layer hybrid disc or other multilayer hybrid discs.

In this case, since recording or reproduction of the backup data is performed using the red semiconductor laser having a relatively long wavelength, the data recording/reproduction margin is larger than that in the case of performing recording/reproduction using the blue-violet semiconductor laser having a relatively short wavelength, and therefore, the backup of the data can be reliably realized. It is desired that the thickness of the light transmission layer in the L2 layer or the L3 layer which stores the backup data should be appropriately set within a range from 0.1 mm to 0.6 mm according to the NA of the lens to be used.

As described above, the optical disc device 600 according to the sixth embodiment is provided with the objective lens which focuses the light beam, the lens actuator which drives the objective lens, the light-receiving unit which receives the light beam reflected at the optical disc and converts the light beam into an electric signal, and the data recording/reproduction management unit which manages data recording or data reproduction in or from the respective layers including the first and second information layers, and the data recording/reproduction management unit records the data also in the second information layer as a backup of the data recorded in the first information layer. Therefore, even when the recording into the L0 layer or the L1 layer has failed or when the recorded data cannot be reproduced for some reasons, the desired data can be reproduced from the L2 layer or the L3 layer, and thus the reliability of data recording or data reproduction can be enhanced. Further, when the data recording/reproduction management unit performs the backup by mirror recording, the data recording/reproduction position management is facilitated, and thereby the data can be reproduced more smoothly.

### Embodiment 7

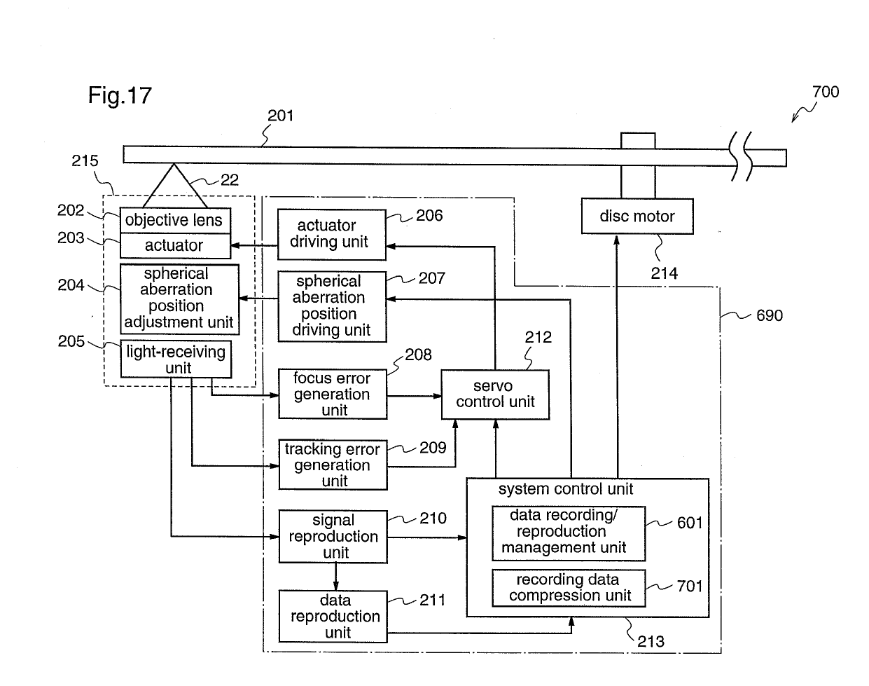

FIG. 17 is a block diagram illustrating the configuration of an optical disc device 700 according to a seventh embodiment of the present invention. The same elements as those shown in FIG. 16 which illustrates the configuration of the optical disc device 600 of the sixth embodiment are given the same reference numerals to omit the description thereof.

Hereinafter, the seventh embodiment will be described with reference to FIG. 17.

The optical disc device 700 of the seventh embodiment shown in FIG. 17 includes a recording data compression unit 701 in addition to the constituents of the sixth embodiment shown in FIG. 16. In FIG. 17, reference numeral 690 denotes a circuit part for exchanging signals with the optical pickup 215, which is provided instead of the circuit part 590 of the sixth embodiment shown in FIG. 16.

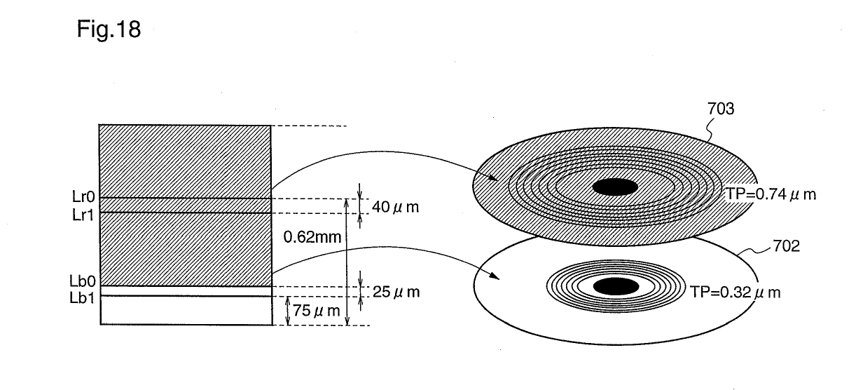

Hereinafter, this seventh embodiment will be described for the case where, as shown in FIG. 18, data are recorded in a Lb0 layer or a Lb1 layer on the BD side in a four-layer hybrid disc including two layers of BD discs 702 and two layers of DVD discs 703 which are described for the sixth embodiment.

When recording data in the Lb0 layer or the Lb1 layer, the data recording/reproduction management unit 601 simultaneously records the same data into the Lr0 layer or the Lr1 layer on the DVD side as backup data. At this time, the data to be recorded in the Lb0 layer or the Lb1 layer are compressed by the recording data compression unit 701, and then the compressed data are recorded in the Lr0 layer or the Lr2 layer. Further, at this time, the above-mentioned compression may be performed in accordance with the recording capacity ratio between the BD disc and the DVD disc, whereby the same operation as the above-mentioned mirror recording can be achieved. That is, when actual video recording is considered, even if failure of recording on the BD side occurs and thereby reproduction becomes impossible, video recording into the DVD side for the specified period of time can be reliably performed although the video quality is degraded.

While the four-layer hybrid disc has been described, this seventh embodiment is also applicable to a two-layer hybrid disc or other multilayer hybrid discs.

As described above, the optical disc device 700 of the seventh embodiment is provided with the objective lens which focuses the light beam, the lens actuator which drives the objective lens, the light-receiving unit which receives the light beam reflected by the optical disc and converts the reflected light into an electric signal, the data recording/reproduction management unit which manages data recording or data reproduction in or from the respective layers including the first and second information layers, and the recording data compression unit which compresses the data to be recorded into the first information layer, and the data recording/reproduction management unit records the data in the second information layer after the data to be recorded in the first information layer is compressed by the recording data compression unit. Therefore, even when such as failure of recording occurs in the BD-side information layer, video recording for specified time can be reliably performed into the DVD-side information layer, and thereby data can be reliably recorded and reproduced although the video quality is degraded.

Further, the data backed up in the Lr0 or Lr1 layer can be reproduced by a legacy DVD apparatus by recording the data in the same format as the DVD such as a modulation method, error correction method, and scrambling, and setting the light transmission layer thickness in the Lr0 layer and the Lr1 layer within a range of 0.0:0.3 mm. For example, a program which has been recorded by the latest BD recorder which is placed in a living room can be taken out to be reproduced by an in-vehicle DVD apparatus, and thus the convenience is high.

### APPLICABILITY IN INDUSTRY

An optical disc device according to the present invention performs status management such as recording inhibition and reproduction inhibition individually for each information layer according to the results of learning performed on the first information layer and the second information layer when a startup process for an optical disc comprising a plurality of layers is performed. Therefore, recording or reproduction can be performed even with only one layer among the plural layers, whereby the user's convenience is enhanced, and the optical disc device is useful particularly when time-shift recording is performed or when recording is suddenly started.

1. An optical disc device which is able to perform data recording and data reproduction in and from an optical disc having laminated M (M≧2) pieces of information layers, said device comprising:
an objective lens which focuses a light beam;
a lens actuator which drives the objective lens;
a light-receiving unit which receives the light beam reflected by the optical disc, and converts the light beam into an electric signal;
a reproduction unit which processes the signal from the light-receiving unit to reproduce a signal on the optical disc;
a control unit which performs, at starting the optical disc device, learning for determining the values of parameters that are set for recording and reproducing data in and from at least one information layer among the M pieces of information layers; and
a management unit which performs setting and management of inhibition or permission for recording or reproduction in or from the respective M pieces of information layers; wherein
said management unit performs setting of inhibition or permission for recording or reproduction to the respective information layers according to the result of the learning performed by the control unit.

2. An optical disc device as defined in claim 1 wherein
when said control unit could have determined the values of the parameters of the respective information layers at startup, said management unit performs setting of inhibition or permission for recording or reproduction to the respective information layers according to the determined values of the parameters of the respective information layers.

3. An optical disc device as defined in claim 1 wherein
when said control unit could not have determined the values of the parameters for any of the information layers at startup, said management unit performs setting of inhibition or permission for recording or reproduction to the respective information layers.

4. An optical disc device as defined in claim 1 wherein
when said reproduction unit could not have read values peculiar to the optical disc or the information layers at startup, which values are recorded in specific areas of the respective information layers, said management unit performs setting of inhibition or permission for recording or reproduction to the respective information layers.

5. An optical disc device as defined in claim 1 wherein
at least one of parameters relating to spherical aberration or focus control is included as the parameters of the respective information layers.

6. An optical disc device as defined in claim 1 wherein
at least one of parameters relating to recording powers or recording compensation values is included as the parameters of the respective information layers.

7. An optical disc device as defined in claim 1 wherein
inter-layer jumping is performed with skipping a recording-inhibited layer or reproduction-inhibited layer in the optical disc, thereby to perform data recording or data reproduction.

8. An optical disc device as defined in claim 1 wherein
flags are set on R (1≦R≦M) pieces of information layers among the M pieces of information layers in the optical disc, and
when the values of the parameters could not have been determined for N (N≦R) pieces of information layers among the R pieces of information layers at starting the optical disc device, the information layers for which the parameter values could not have been determined are hidden by the flags, thereby to control the optical disc as a (M−N) layer disc.

9. An optical disc device as defined in claim 8 wherein
said optical disc is a two-layer disc having two information layers; and
when the values of the parameters could not have been determined for one of the two information layers, which is closer to a light incident surface of the optical disc, the optical disc is controlled as a single-layer disc.

10. An optical disc device as defined in claim 8 wherein
the values of the parameters of the respective information layers which have been determined by the control unit and information as to whether the control unit could have determined the values of the parameters of the respective information layers or not are recorded in a predetermined area of the optical disc.

11. An optical disc device as defined in claim 10 wherein
when the values of the parameters could not have been determined for N (N≦R) information layers among the R information layers at starting the optical disc device, information for identifying the optical disc as a (M−N) layer disc is recorded in a predetermined area of any information layer among the information layers for which the values of the parameters could have been determined.

12. An optical disc device as defined in claim 8 wherein
information of recording inhibition or reproduction inhibition for the respective information layers, which is set by the management unit, is recorded in a predetermined area of the optical disc.

13. An optical disc device as defined in claim 12 further including:
a finalization unit which performs finalization for fabrication of a recordable optical disc; and
said finalization unit being operated to embed arbitrary data in an unrecorded area of the recordable optical disc, thereby to finalize fabrication of a recordable optical disc.

14. An optical disc device as defined in claim 8 wherein
when the optical disc is controlled as a (M−N) layer disc, data recording or data reproduction is performed with using a logical address at the head of an information layer for which the values of the parameters could have been determined among the information layers in the (M−N) layer disc, as a start address of the (M−N) layer disc.

15. An optical disc device as defined in claim 8 wherein
when data recording or data reproduction is controlled with the optical disc being a (M−N) layer disc, data recording or data reproduction is performed with using a final logical address of an information layer for which the values of the parameters could have been determined among the information layers in the (M−N) layer disc, as a final address of the (M−N) layer disc.

16. An optical disc device which is able to perform data reproduction from an optical disc having laminated M (M≧2) pieces of information layers, said device comprising:
an objective lens which focuses a light beam;
a lens actuator which drives the objective lens;
a light-receiving unit which receives the light beam reflected by the optical disc, and converts the light beam into an electric signal;
a reproduction unit which processes the signal from the light-receiving unit to reproduce a signal on the optical disc; and
an identification unit which identifies the optical disc; wherein
values of parameters which are set for reproducing data from the respective information layers, and identification information indicating whether the values of the parameters could have been determined for the respective information layers or not are recorded in a predetermined area of the optical disc, and
said identification unit reads out the identification information to identify the optical disc.

17. An optical disc device as defined in claim 16 wherein
when information indicating that the values of the parameters could not have been determined for any N (M>N) pieces of layers among the M pieces of information layers is recorded in the optical disc as the identification information, said optical disc is controlled as a (M−N) layer disc.

18. An optical disc which is obtained by laminating M (M≧2) pieces of layers including spare layers.

19. An optical disc as defined in claim 18 wherein
said M pieces of layers include layers which are determined in the standard or specification of the optical disc, and spare layers, and
information indicating the number of actually laminated layers including the number of the layers determined in the standard or specification of the optical disc and the number of the spare layers is recorded in a predetermined area.

20. An optical disc as defined in claim 18 wherein
when the values of the parameters to be set for data recording or data reproduction could not have been determined for N (M>N) pieces of layers among the M pieces of layers, information for identifying the optical disc as a (M−N) layer disc is recorded.

21. An optical disc as defined in claim 19 being a parallel track path system multilayer disc.

22. An optical disc as defined in claim 19 being an opposite track path system multilayer disc.

23. An optical disc device which can perform data reproduction from an optical disc having laminated M (M≧2) pieces of information layers, said device comprising:
an objective lens which focuses a light beam;
a lens actuator which drives the objective lens;
a light-receiving unit which receives the light beam reflected at the optical disc, and converts the light beam into an electric signal;
a reproduction unit which processes the signal from the light-receiving unit to reproduce a signal on the optical disc; and
a standard number-of-layers identification unit which identifies the number of layers in the optical disc; wherein
said optical disc includes laminated M (M≧2) pieces of layers including spare layers, said M pieces of layers comprising layers that are determined in the standard or specification of the optical disc and the spare layers, and information indicating the number of the actually laminated layers including the number of the layers determined in the standard or specification of the optical disc and the number of the spare layers is recorded in a predetermined area,
said standard number-of-layers identification unit identifies the number of the layers determined in the standard or specification, from the information relating to the number of layers, and
only the layers in the number determined in the standard or specification, which are identified by the standard number-of-layers identification unit, are used for data reproduction.

24. An optical disc device as defined in claim 23 further including:
an address conversion unit which converts discontinuous physical addresses into continuous logical addresses by using addresses of only the layers in the number determined in the standard or specification of the optical disc.

25. An optical disc device as defined in claim 24 wherein
said address conversion unit converts discontinuous physical addresses into continuous logical addresses by using addresses of only the layers in the number determined in the standard or specification so that track paths of the optical disc are alternate track paths.

26. An optical disc device which can perform data recording and data reproduction in and from an optical disc having laminated M (M≧2) pieces of information layers, said device comprising:
an objective lens which focuses a light beam;
a lens actuator which drives the objective lens;
a light-receiving unit which receives the light beam reflected at the optical disc, and converts the light beam into an electric signal;
a reproduction unit which processes the signal from the light-receiving unit to reproduce a signal on the optical disc; and
a data recording/reproduction management unit which manages the data recorded or reproduced in or from each of the M pieces of information layers; wherein
said data recording/reproduction management unit records backup data of the recording data to be recorded in the respective information layers, in information layers different from the information layers in which the recording data are recorded.

27. An optical disc device as defined in claim 26 wherein
said data recording/reproduction management unit performs mirror recording which makes the recording data and the backup data equal to each other, and makes the recording positions of the recording data in the information layers and the recording positions of the backup data in the information layers equal to each other, when recording the backup data in the respective information layers.

28. An optical disc device which is able to perform data recording and data reproduction in and from an optical disc including M (M≧2) pieces of information layers having different physical configurations from each other, said device comprising:
an objective lens which focuses a light beam;
a lens actuator which drives the objective lens;
a light-receiving unit which receives the light beam reflected by the optical disc, and converts the light beam into an electric signal;
a reproduction unit which processes the signal from the light-receiving unit to reproduce a signal on the optical disc; and
a data recording/reproduction management unit which manages the data recorded or reproduced in or from each of the M pieces of information layers; wherein
said data recording/reproduction unit records backup data of the recording data to be recorded in the respective information layers, in information layers different from the information layers in which the recording data are recorded.

29. An optical disc device as defined in claim 28 further including:
a recording data compression unit for compressing the recording data, and
said recording/reproduction management unit recording the backup data after the recording data to be recorded in the respective information layers are compressed by the recording data compression unit.

30. An optical disc device as defined in claim 28 wherein
said data recording/reproduction management unit reproduces the backup data corresponding to the recording data when the recording data recorded in the respective information layers cannot be reproduced.

31. An optical disc device as defined in claim 28 wherein
said backup data has a recording format which can be reproduced by an optical disc device which can reproduce only the information layers in which the backup data are recorded.

32. An optical disc including M (M≧2) pieces of information layers having different physical configurations from each other, wherein
backup data of recording data to be recorded in the respective information layers are recorded in information layers different from the information layers in which the recording data are recorded;
said backup data are recorded in a recording format which is reproducible by an optical disc device that can reproduce only the information layers in which the backup data are recorded; and
the thickness of a light transmission layer in the information layer in which the backup data are recorded is 0.6 mm±0.03 mm.
